(19) United States
(12) Patent Application Publication
(10) Pub. No.: US 2026/0197405 A1
(43) Pub. Date: Jul. 9, 2026

(54) IMAGE PROCESSING APPARATUS, METHOD OF CONTROLLING IMAGE PROCESSING APPARATUS, AND STORAGE MEDIUM

(71) Applicant: CANON KABUSHIKI KAISHA, Tokyo (JP)

(72) Inventor: ASAMI ITO, Kanagawa (JP)

(21) Appl. No.: 19/440,715

(22) Filed: Jan. 6, 2026

(30) Foreign Application Priority Data
Jan. 8, 2025 (JP) 2025-002820
Jul. 17, 2025 (JP) 2025-120535

(51) Int. Cl. H04N 1/00

(52) U.S. Cl. CPC H04N 1/00029; H04N 1/00076

(57) ABSTRACT

An image processing apparatus including a display unit displaying various information includes: an obtaining unit configured to obtain, based on a predetermined condition, an available method from among a plurality of different methods in which a diagnosis result of an error that has occurred during an operation of the image processing apparatus is confirmed in methods different from displaying the diagnosis result on the display unit; and a display control unit configured to display a screen on the display unit, the screen displaying the available method obtained by the obtaining unit in a selectable mode. The display control unit displays, on the display unit, an unavailable method among the plurality of different methods in an unselectable mode in the screen.

### BACKGROUND

### Field of the Technology

The present disclosure relates to display control of an image processing apparatus.

### Description of the Related Art

In a case where printing, image transmission, or facsimile transmission is performed by using an image processing apparatus, error termination sometimes occurs. Moreover, even if the operation is normally terminated, a desired output result for an output product sometimes cannot be obtained. A function that allows a user to solve problems on one's own in such cases is provided. As an example of such a function, there is a function in which an image processing apparatus performs internal diagnosis for a job in which a problem has occurred, and presents a result of the internal diagnosis.

As a method of presenting the diagnosis result, there is a method of presenting information on an operation screen on the image processing apparatus (local user interface, hereinafter, referred to as "local UI"). Alternatively, there is a method of presenting information by using a two-dimensional code that enables confirmation by printing, e-mail transmission, or web browser or by using a remote user interface (hereinafter, referred to as "remote UI") function that allows information on the image processing apparatus to be displayed and manipulated on a browser. Accordingly, there are multiple functions for presenting the diagnosis result. As an example of a method of presenting multiple functions to a user, Japanese Patent Laid-Open No. 2007-259307 (referred to as "Document 1") discloses a technique in which only the available functions are displayed according to rights of a log-in user, and absence of rights of use is displayed for unavailable functions.

In the technique according to Document 1, display control of the available functions is performed with reference to only the user rights for the image processing apparatus. Accordingly, for a problem of "printing cannot be performed", a method of presenting the diagnosis result that is not suitable for this problem such as "printing" is sometimes presented as the method of presenting the diagnosis result. Since the unavailable function is also presented in a selectable state, there is a possibility that the user erroneously selects the unavailable function. There is a demand for improving usability in the method of presenting the diagnosis result of the image processing apparatus.

### SUMMARY

An image processing apparatus according to the present disclosure including a display unit displaying various information, includes: one or more processors and/or circuitry which function as: an obtaining unit configured to obtain, based on a predetermined condition, an available method from among a plurality of different methods in which a diagnosis result of an error that has occurred during an operation of the image processing apparatus is confirmed in methods different from displaying the diagnosis result on the display unit; and a display control unit configured to display a screen on the display unit, the screen displaying the available method obtained by the obtaining unit in a selectable mode, and the display control unit displays, on the display unit, an unavailable method among the plurality of different methods in an unselectable mode in the screen.

Features of the present disclosure will become apparent from the following description of embodiments with reference to the attached drawings. The following description of embodiments is described by way of example.

### BRIEF DESCRIPTION OF THE DRAWINGS

FIG. 1 is a system configuration diagram according to the present disclosure;

FIG. 2 is an internal configuration diagram of a controller unit in an image processing apparatus;

FIG. 3 is a block configuration diagram of software executed by the controller unit of the image processing apparatus;

FIG. 4 is a sequence chart of an example in which e-mail transmission fails;

FIG. 5A is a diagram illustrating an example of a home screen of the image processing apparatus;

FIG. 5B is a diagram illustrating an example of an operation screen of the image processing apparatus in the e-mail transmission;

FIG. 5C is a diagram illustrating an example of the operation screen of the image processing apparatus in the e-mail transmission;

FIG. 5D is a diagram illustrating an example of the operation screen of the image processing apparatus in the e-mail transmission;

FIG. 5E is a diagram illustrating an example of the operation screen of the image processing apparatus in a case where the e-mail transmission fails;

FIG. 6 is a sequence chart illustrating a process in which a job selected from a job history is diagnosed;

FIG. 7A is a diagram illustrating an example of a job history screen displayed in the image processing apparatus;

FIG. 7B is a diagram illustrating an example of the job history screen displayed in the image processing apparatus;

FIG. 8A is a diagram illustrating an example of a device operation state screen displayed in the image processing apparatus;

FIG. 8B is a diagram illustrating an example of a trouble response screen displayed in the image processing apparatus;

FIG. 9A is a diagram illustrating an example of a diagnosis result screen displayed in the image processing apparatus;

FIG. 9B is a diagram illustrating an example of the diagnosis result screen displayed in the image processing apparatus;

FIG. 9C is a diagram illustrating an example of a confirmation-in-different-method screen displayed in the image processing apparatus;

FIG. 10 is a diagram illustrating examples of a diagnosis result and countermeasures;

FIG. 11A is a diagram illustrating an example of the diagnosis result screen;

FIG. 11B is a diagram illustrating an example of the diagnosis result screen;

FIG. 12 is a flowchart illustrating a process of controlling display of the confirmation-in-different-method screen;

FIG. 13 is a diagram illustrating an example of an internal diagnosis matter list;

FIG. 14 is a diagram illustrating an example of the confirmation-in-different-method screen;

FIG. 15 is a diagram illustrating an example of a setting screen of the image processing apparatus;

FIG. 16 is a flowchart illustrating a process of controlling display of the confirmation-in-different-method screen;

FIG. 17 is a diagram illustrating an example of the confirmation-in-different-method screen;

FIG. 18 is a diagram illustrating an example of the diagnosis result screen;

FIG. 19 is a sequence chart illustrating a display process of a guide screen for confirming a diagnosis result of a job on a remote UI;

FIG. 20 is a diagram illustrating an example of the job history screen displayed in the image processing apparatus;

FIG. 21 is a diagram illustrating an example of a remote UI guiding screen displayed in the image processing apparatus;

FIG. 22 is a diagram illustrating an example of an e-mail for requesting response to an administrator based on the diagnosis result;

FIG. 23 is a diagram illustrating an example of an e-mail for confirming the diagnosis result on the remote UI;

FIG. 24 is a diagram illustrating an example of the operation screen of the image processing apparatus in a case where the e-mail transmission fails;

FIG. 25 is a flowchart illustrating a process of controlling display of e-mail notification;

FIG. 26 is a diagram illustrating an example of a termination code list relating to the display of e-mail notification;

FIG. 27 is a diagram illustrating an example of the remote UI guiding screen displayed in the image processing apparatus; and

FIG. 28 is a diagram illustrating an example of the diagnosis result screen.

### DESCRIPTION OF THE EMBODIMENTS

Hereinafter, embodiments of the present disclosure are described with reference to the accompanying drawings. The following embodiments do not limit the present disclosure, and not all the combinations of features described in the embodiments are essential to the solution of the present disclosure. The same components are described with the same reference numerals. The steps in the flowcharts are denoted by reference numerals starting with "S".

### First Embodiment

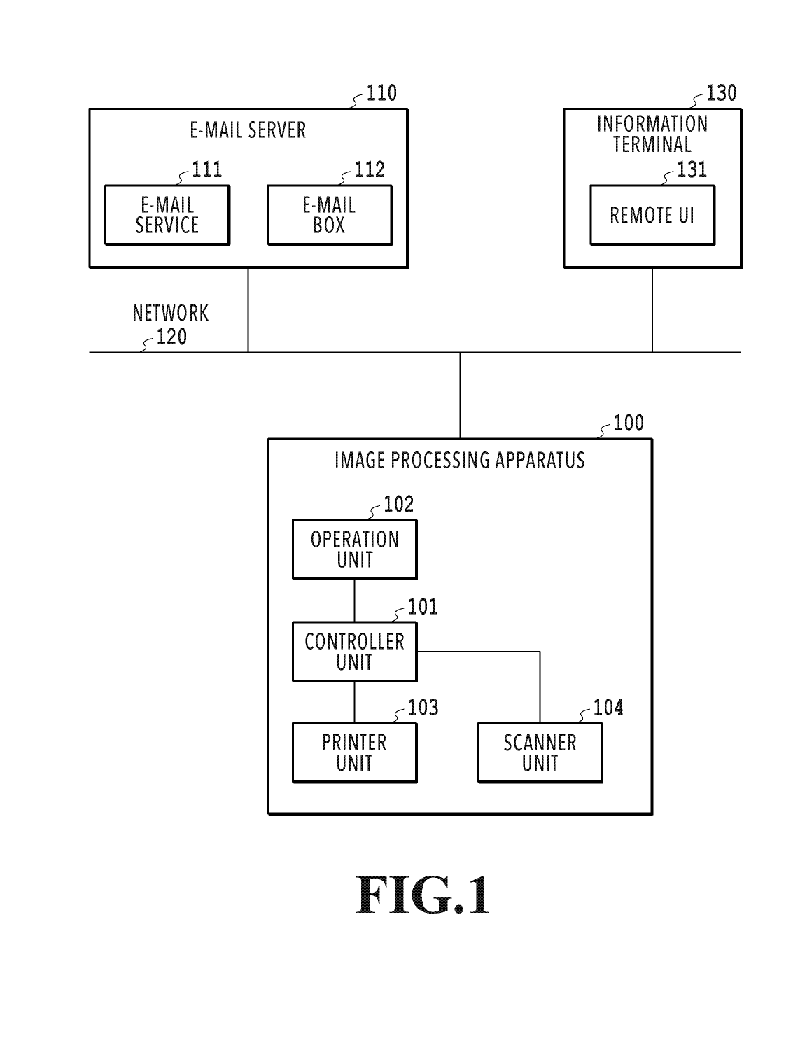

FIG. 1 illustrates an example of a system configuration of the present embodiment. A system in the present embodiment includes an image processing apparatus 100, an e-mail server 110, and an information terminal 130. The image processing apparatus 100, the e-mail server 110, and the information terminal 130 are connected to one another via a network 120. In the present embodiment, the network 120 may be wired connection or wireless connection.

The image processing apparatus 100 reads an image with a scanner unit, prints an image with a printer unit, and exchanges e-mails via the e-mail server 110. The image processing apparatus 100 includes an operation unit 102 that performs input and output with a user. The operation unit 102 may be a touch panel (display device) that displays a user interface screen (UI screen). Moreover, selecting buttons displayed on the UI screen causes functions included in the image processing apparatus 100 to be executed. Selection of the functions and the like displayed on the UI screen is not limited to soft buttons described above, and may be hard buttons (not illustrated). The image processing apparatus 100 includes a printer unit 103 that outputs electronic data to a print medium. The image processing apparatus 100 includes a scanner unit 104 that reads a print medium and converts the print medium to electronic data. The operation unit 102, the printer unit 103, and the scanner unit 104 are connected to a controller unit 101, and execute functions as a multi-function peripheral according to control of the controller unit 101.

The e-mail server 110 includes an e-mail service 111 and an e-mail box 112. The e-mail service 111 receives an instruction from the image processing apparatus 100, and provides a function of transmitting an e-mail according to simple mail transfer protocol (SMTP) predefined in RFC 5321. Moreover, the e-mail service 111 receives an instruction from the image processing apparatus 100, and provides a function of receiving an e-mail stored in the e-mail box 112 according to POP predefined in RFC 5034 and IMAP predefined in RFC 3501. Here, POP is an abbreviation of post office protocol, and IMAP is an abbreviation of Internet message access protocol.

The information terminal 130 includes a remote UI 131 displayed on a web browser. Although there is one information terminal 130 in FIG. 1, there may be multiple information terminals 130. Examples of the information terminal include a smartphone, a tablet terminal, a personal computer (PC), and the like. Note that only the configurations for explaining the present embodiment are illustrated in FIG. 1. Other configurations may be included as long as the embodiment of the present disclosure can be satisfied, and connection forms between the components are not limited to the illustrated forms.

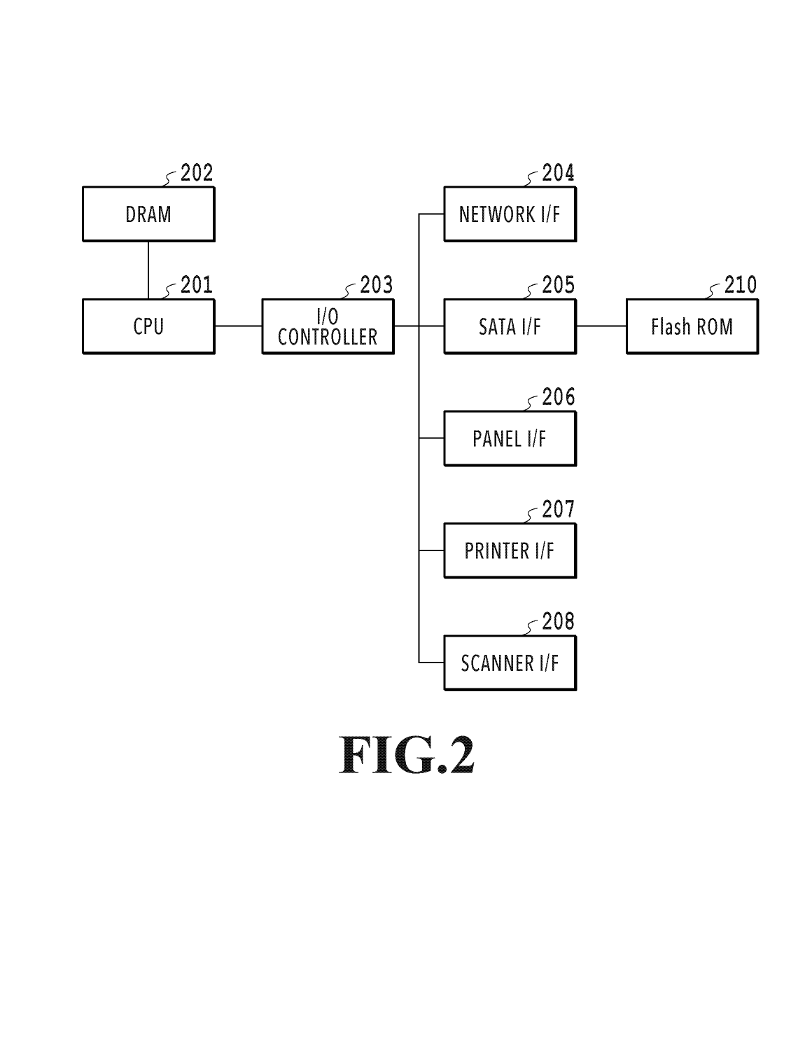

FIG. 2 is a block diagram illustrating details of the controller unit 101 of the image processing apparatus 100. A CPU 201 performs main arithmetic processing in a controller. The CPU 201 is connected to a DRAM 202 via a bus. The DRAM 202 is used by the CPU 201 as a work memory for temporarily arranging program data expressing computation commands and data to be processed in processes of computation by the CPU 201. The CPU 201 is connected to an I/O controller 203 via the bus. The I/O controller 203 performs input and output from and to various devices according to instructions of the CPU 201. A serial advanced technology attachment (SATA) I/F 205 is connected to the I/O controller 203. Moreover, the SATA I/F 205 is connected to a flash ROM 210. The CPU 201 uses the flash ROM 210 to permanently store programs and document files for implementing the functions of the image processing apparatus. A large-capacity storage device such as hard disk drive (HDD) or a solid state drive (SSD) may be connected instead of the flash ROM. A network I/F 204 is connected to the I/O controller 203. A wired LAN device or a wireless LAN device is connected to the network I/F 204. The CPU 201 controls the wired LAN device or the wireless LAN device via the network I/F 204 to achieve communication on the network 120. A panel I/F 206 is connected to the I/O controller 203, and the CPU 201 implements user input from and output to the operation unit 102 via the panel I/F 206. A printer I/F 207 is connected to the I/O controller 203, and the CPU 201 implements an output process to a print medium using the printer unit 103 via the printer I/F 207.

In the image processing apparatus 100, there are various applications for using the functions of the image processing apparatus. As an example, there are a copy function, a transmission function, a facsimile function, a box function, and the like. For example, in a case where the copy function is executed, the CPU 201 loads program data from the flash ROM 210 into the DRAM 202 via the SATA I/F 205. The CPU 201 detects a copy instruction from the user performed on the operation unit 102 via the panel I/F 206 according to the program loaded into the DRAM 202. In a case where the CPU 201 detects the copy instruction, the CPU 201 receives an original from the scanner unit 104 via a scanner I/F 208 as electronic data, and stores the electronic data in the DRAM 202. The CPU 201 executes a color conversion process and the like suiting output, on the image data stored in the DRAM 202. The CPU 201 transfers the image data stored in the DRAM 202 to the printer unit 103 via the printer I/F 207, and executes an output process to the print medium.

In the transmission function, a process in which the CPU 201 detects a transmission instruction from the user is the same as the process in the copy function described above. The transmission instruction includes a transmission protocol, a transmission destination designation, an image format, and the like from the user. The transmission protocol is server message block (SMB), file transfer protocol (FTP), e-mail (SMTP), or the like. The transmission destination designation is, for example, designation in universal naming convention (UNC). An image format is JPEG, PDF, or the like. In a case where the CPU 201 detects the transmission instruction, the CPU 201 receives an original from the scanner unit 104 via the scanner I/F 208 as electronic data, and stores the electronic data in the DRAM 202. The CPU 201 performs processes such as converting a format of the image data stored in the DRAM 202 to an image format designated by the user. The CPU 201 transmits the image data stored in the DRAM 202 to a transmission destination via the network I/F 204 according to a protocol designated by the user.

In the facsimile function, a process in which the CPU 201 detects a facsimile instruction from the user is the same as the process in the copy function described above. In a case where the CPU 201 detects the facsimile instruction, the CPU 201 receives an original from the scanner unit 104 via the scanner I/F 208 as electronic data, and stores the electronic data in the DRAM 202. The CPU 201 performs processes such as converting an image format of the image data stored in the DRAM 202 to an image format for facsimile. The CPU 201 transmits the image data stored in the DRAM 202 to a phone number or the like of a facsimile designated in the facsimile instruction via a phone line network (not illustrated) or the like to which a facsimile I/F 209 is connected. The facsimile using the phone line is an example, and the facsimile may be an Internet facsimile in some cases.

The box function is a function of storing a scanned image in a storage area inside the image processing apparatus 100 or a memory medium connected to the image processing apparatus 100. Furthermore, the box function includes a function of making an image stored in the image processing apparatus 100 available to an external PC (not illustrated) or another image processing apparatus by causing the image processing apparatus 100 to function as a file server. In the box function, a process in which the CPU 201 detects a storing-to-box instruction from the user is the same as the process in the copy function described above. The storing-to-box instruction includes a storing destination designation, an image format designation, and the like from the user. The storing destination is a path of the internal storage of the image processing apparatus 100 or the memory medium connected to the image processing apparatus 100. The image format is JPEG, PDF, or the like. In a case where the CPU 201 detects the storing-to-box instruction, the CPU 201 receives an original from the scanner unit 104 via the scanner I/F 208 as electronic data, and stores the electronic data in the DRAM 202. The CPU 201 performs processes such as converting an image format of the image data stored in the DRAM 202 to an image format designated by the user. The CPU 201 transfers the image data stored in the DRAM 202 to the storing destination designated by the user such as the flash ROM 210 inside the image processing apparatus 100 or the memory medium (not illustrated) via the SATA I/F 205, and stores this data.

In the facsimile function, the CPU 201 may convert the received image to image data of a format browsable on a PC or the like, and store the image data in the box, instead of printing the received image. Moreover, as the box function, the image processing apparatus 100 may make contents of the flash ROM 210 available by functioning as a file server such as a SMB server. In the box function, the CPU 201 detects a box access instruction from the outside via the network I/F 204. The box access instruction includes an image file path of access destination and the like. The CPU 201 transfers image data stored in the flash ROM 210 and corresponding to the designated image file path, to a request source of the box access instruction via the network I/F 204. Note that the above-mentioned functions are examples of the functions of the image processing apparatus 100, and other functions may be included.

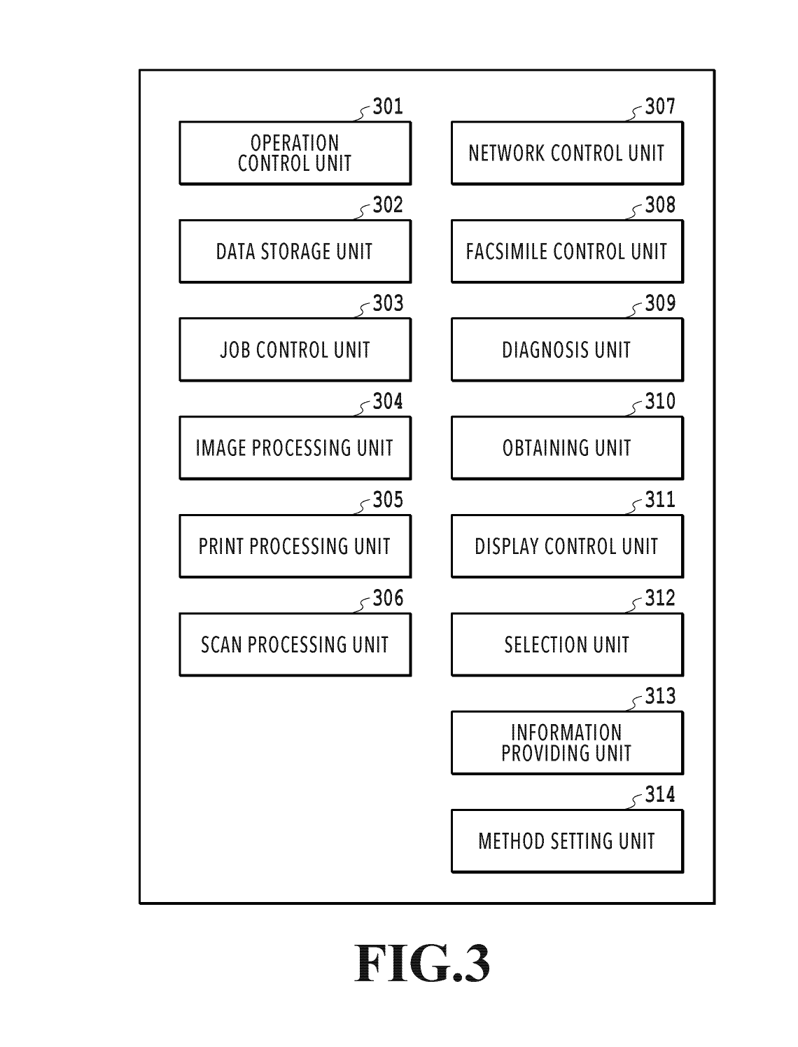

FIG. 3 is a block diagram illustrating a configuration of software executed by the CPU 201 of the image processing apparatus 100 according to the present embodiment. All pieces of software executed in the controller unit 101 are executed after the CPU 201 loads a program stored in the flash ROM 210 into the DRAM 202. An operation control unit 301 displays the UI screen for the user on the operation unit 102, detects user operations, and executes processes associated with screen parts such as the buttons displayed on the UI screen. A data storage unit 302 stores requests from the other control units into the flash ROM 210, and reads the requests from the flash ROM 210. A job control unit 303 performs control of executing jobs according to instructions from the other control units. An image processing unit 304 processes the image data into a format suiting each application, according to an instruction from the job control unit 303. A print processing unit 305 prints an image on a print medium via the printer I/F 207, according to an instruction from the job control unit 303. A scanning processing unit 306 scans a designated original via the scanner I/F 208, according to an instruction from the job control unit 303. A network control unit 307 performs input and output of data via a wired LAN, a wireless LAN such as Wi-Fi (registered trademark), or a public line network via the network I/F 204, according to instructions from the various control units. Moreover, the network control unit 307 allows the data storage unit 302 to perform accessing of the data stored in the flash ROM 210 from an external device via the network control unit 307. An example of the data stored in the flash ROM 210 includes image data of JPEG, PDF, or the like. A facsimile control unit 308 performs a process of receiving received facsimile data from the network control unit 307, according to an instruction from the job control unit 303. Moreover, the facsimile control unit 308 instructs the print processing unit 305 to print the received facsimile data. Furthermore, the facsimile control unit 308 converts the received facsimile data to image data of JPEG, PDF, or the like, and stores the image data in the data storage unit 302. The facsimile control unit 308 performs facsimile transmission of image data scanned by the scanning processing unit 306, via the network control unit 307.

In a case where diagnosis of a job whose execution failed is instructed during an operation of the image processing apparatus 100, a diagnosis unit 309 diagnosis the cause of this failure based on information in job execution, and infers an error that has occurred. An obtaining unit 310 obtains available methods from among plural methods in which a diagnosis result of the error diagnosed in the diagnosis unit 309 is confirmed and that are different from displaying the diagnosis result on the operation unit 102 to confirm the diagnosis result. A display control unit 311 performs display control of the UI screen, various pieces of information, and the like displayed on the operation unit 102. Pressing a button displayed on the UI screen or the like allows a selection unit 312 to detect a selected process or the like. An information providing unit 313 provides the diagnosis result of the error, in a method selected through the selection unit 312 from among the available methods obtained in the obtaining unit 310. A method setting unit 314 sets available or unavailable for each of the plural methods that are methods different from displaying the diagnosis result on the operation unit 102.

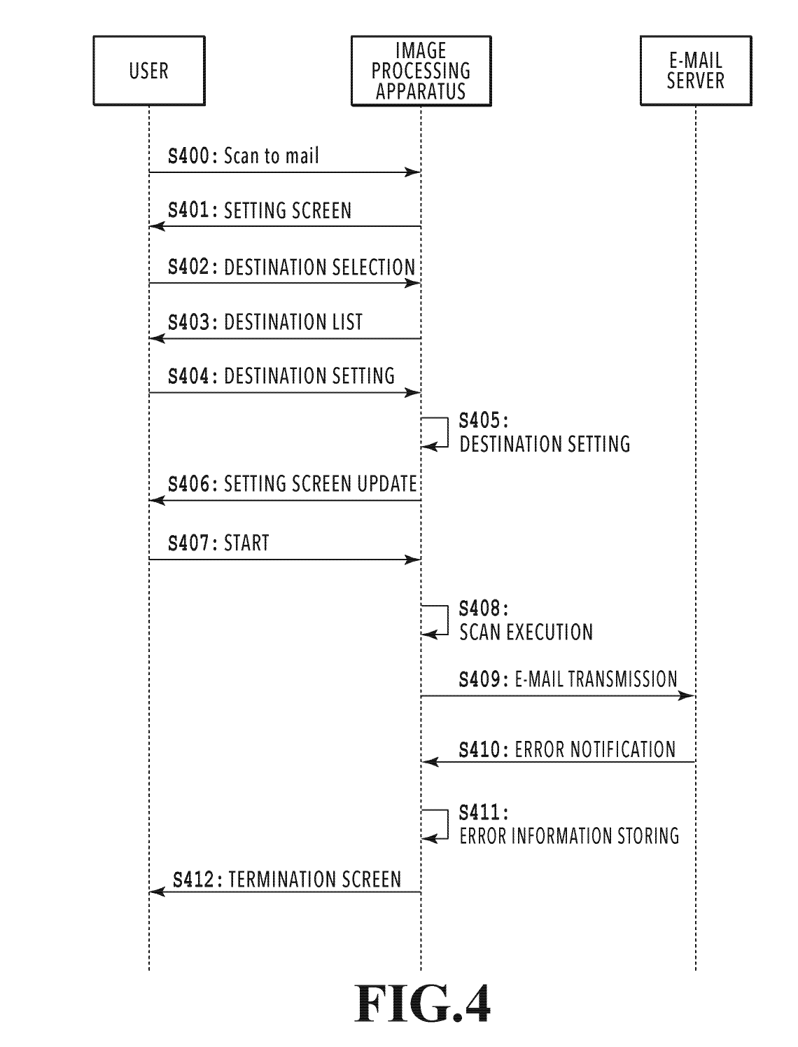

An operation of internal diagnosis of the image processing apparatus 100 in the present embodiment is explained in detail by using FIGS. 4 to 11B. FIG. 4 is a sequence chart illustrating an example in which the image processing apparatus 100 fails in e-mail transmission. In the present embodiment, the image processing apparatus 100 executes the e-mail transmission, and then performs diagnosis for a job in which the transmission has failed. Explanation of operations that are not essential to the present embodiment is omitted in the following sequence. Moreover, the CPU 201 implements the processes of the sequence chart of FIG. 4 by expanding a program stored in the flash ROM 210 onto the DRAM 202 and executing the program.

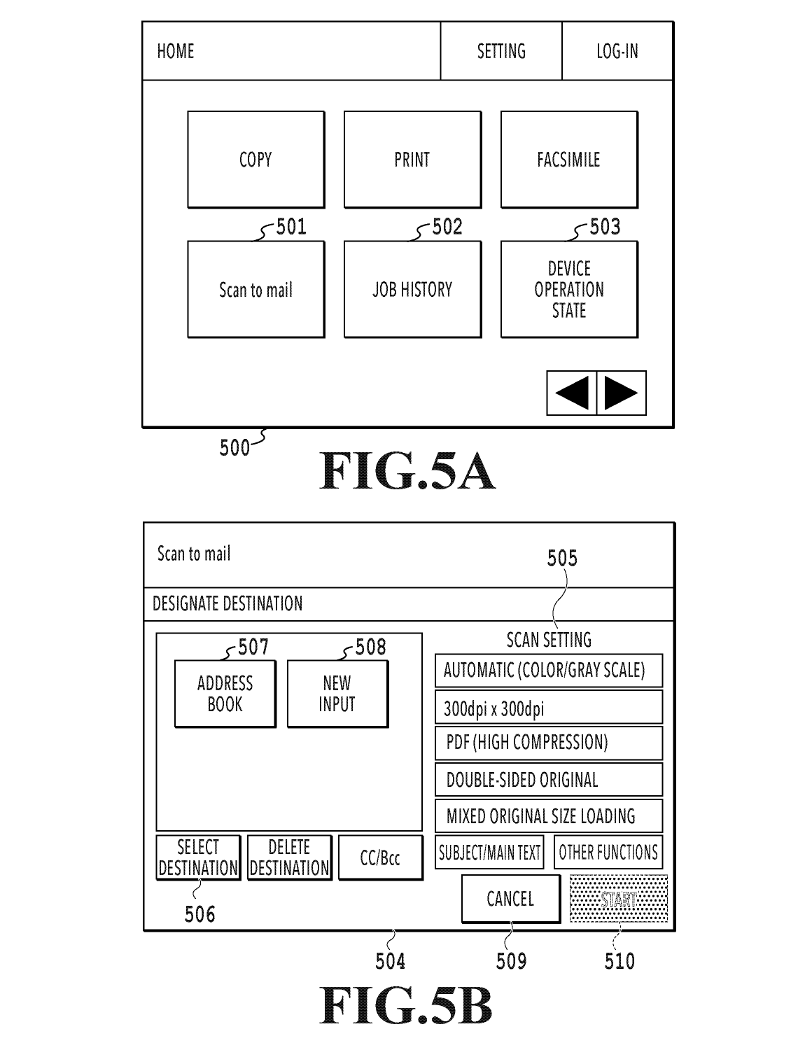

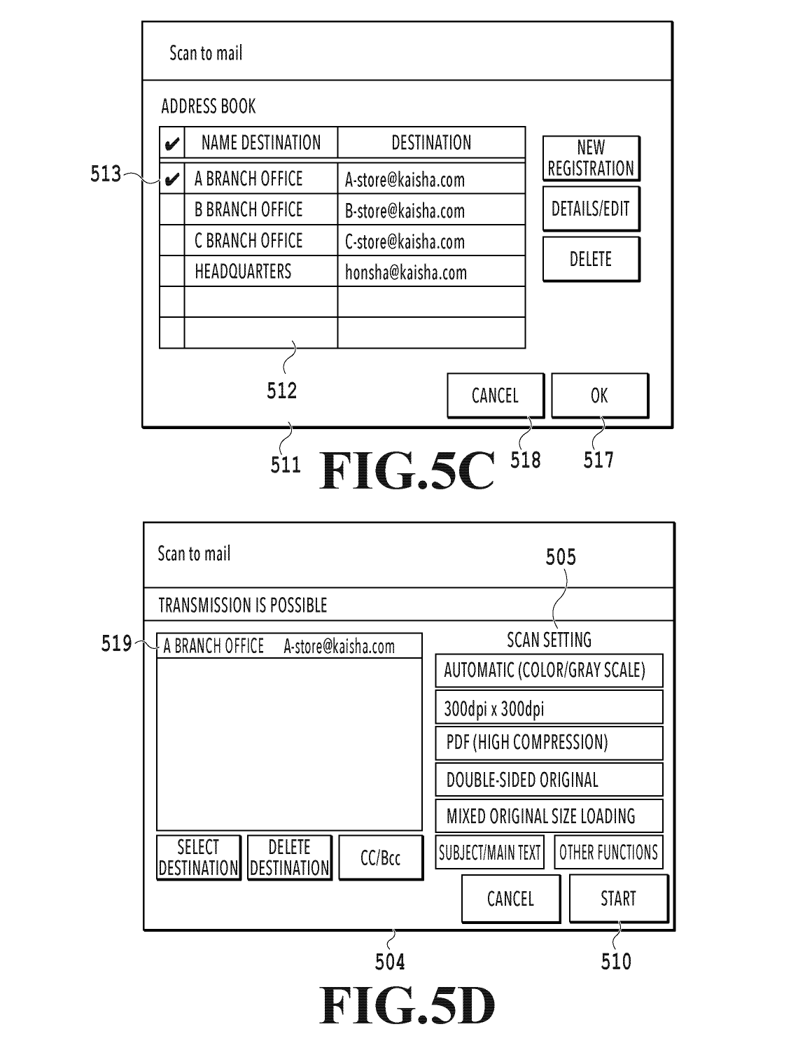

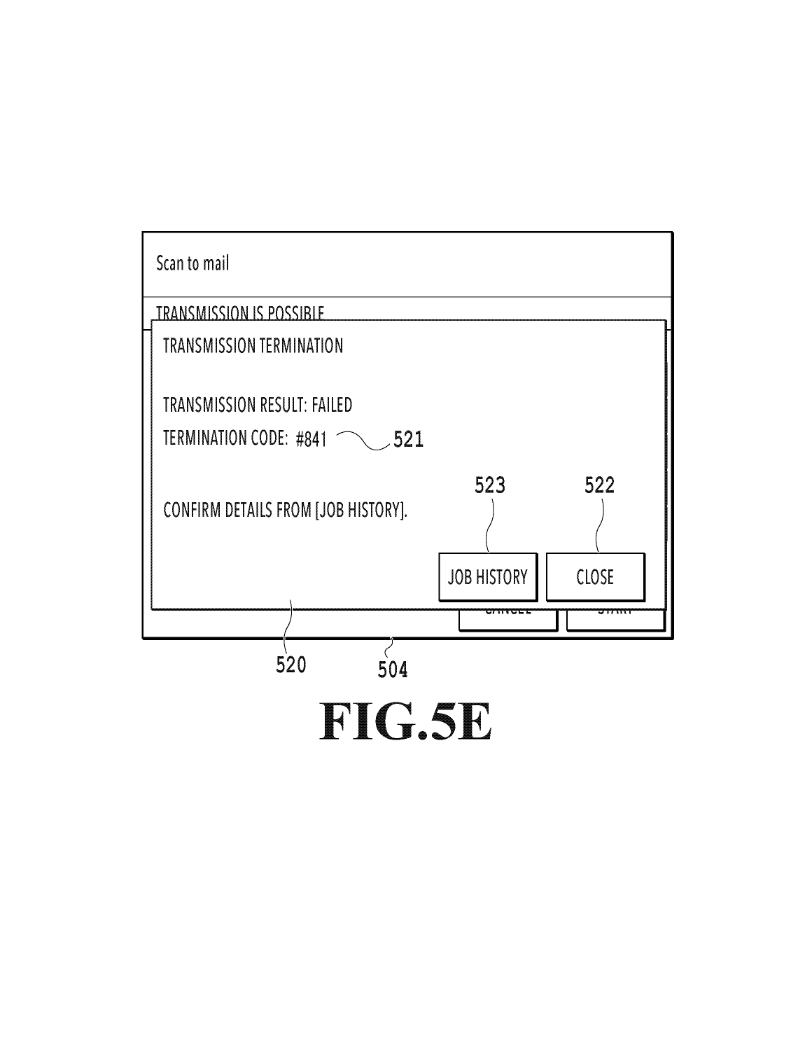

First, in a case where the image processing apparatus 100 is activated, a home screen 500 illustrated in FIG. 5A is displayed on the operation unit 102. Buttons for invoking functions such as copy and print are arranged on the home screen 500. Moreover, user authentication may be used, but since this is not a matter directly related to the present embodiment, explanation thereof is omitted herein.

In S400, in a case where the user presses a scan-to-mail button 501, a scan-to-mail function is invoked. In S401, the CPU 201 of the image processing apparatus 100 displays a scan-to-mail setting screen 504 illustrated in FIG. 5B on the operation unit 102. In a case where the user presses a start button 510, the CPU 201 transmits, by e-mail, electronic data scanned based on scanning set in a scan setting 505 to a destination set by pressing a destination selection button 506. The scan setting 505 is used in a case where a color, a size, and the like in the reading are set. Scan settings other than the settings displayed in FIG. 5B may be set by using the scan setting 505. In a case where the destination is not selected by the user, the start button 510 is grayed out, and the scan-to-mail function cannot be started. Moreover, in a case where the user presses a cancel button 509, the CPU 201 closes the scan-to-mail setting screen 504, and displays the home screen 500 on the operation unit 102.

In S402, in a case where the user presses the destination selection button 506 and presses an address book button 507, an address book is invoked. In S403, the CPU 201 displays a destination list screen 511 illustrated in FIG. 5C on the operation unit 102. In a case where the user presses a new input button 508 in this situation, the CPU 201 displays a destination registration screen on the operation unit 102. Note that explanation of an operation of destination registration is omitted herein. A destination list 512 of destinations that are registered in the image processing apparatus 100 and whose communication protocol types are "mail" are displayed on the destination list screen 511. In a case where the user presses a cancel button 518, the CPU 201 closes the destination list screen 511 without selecting a destination, and displays the scan-to-mail setting screen 504 on the operation unit 102. For example, in a case where the user selects a destination 513 whose name is "A branch office" and whose destination is "A-store@kaisha.com", the CPU 201 adds a confirmation to a first column of a table of the destination list 512. The user may select multiple destinations in this case.

In S404, in a case where the user presses an OK button 517 in a state where the destination 513 is selected, the destination is selected. In S405, the CPU 201 sets the selected destination 513 as an e-mail transmission destination. In S406, in a case where the destination is set in S405, as illustrated in FIG. 5D, the CPU 201 updates the scan-to-mail setting screen 504. On the updated scan-to-mail setting screen 504, information on the destination 513 selected in S404 is displayed in a transmission destination list 519.

In S407, in a case where the user presses the start button 510, the scan-to-mail function is started. In S408, the CPU 201 executes scanning according to the scan setting 505. In S409, the CPU 201 attaches scan data to an e-mail, and transmits the e-mail to the e-mail server 110 according to the SMTP protocol. In S410, the e-mail transmission fails due to a cause such as a setting error, and the e-mail server 110 notifies the image processing apparatus 100 of the error. In S411, the CPU 201 of the image processing apparatus 100 analyzes error information based on contents of error notification, and stores the error information in the flash ROM 210. In S412, the CPU 201 displays a termination screen 520 illustrated in FIG. 5E on the operation unit 102. In a case where the termination screen 520 is displayed on the operation unit 102, the process of the sequence chart illustrated in FIG. 4 is terminated.

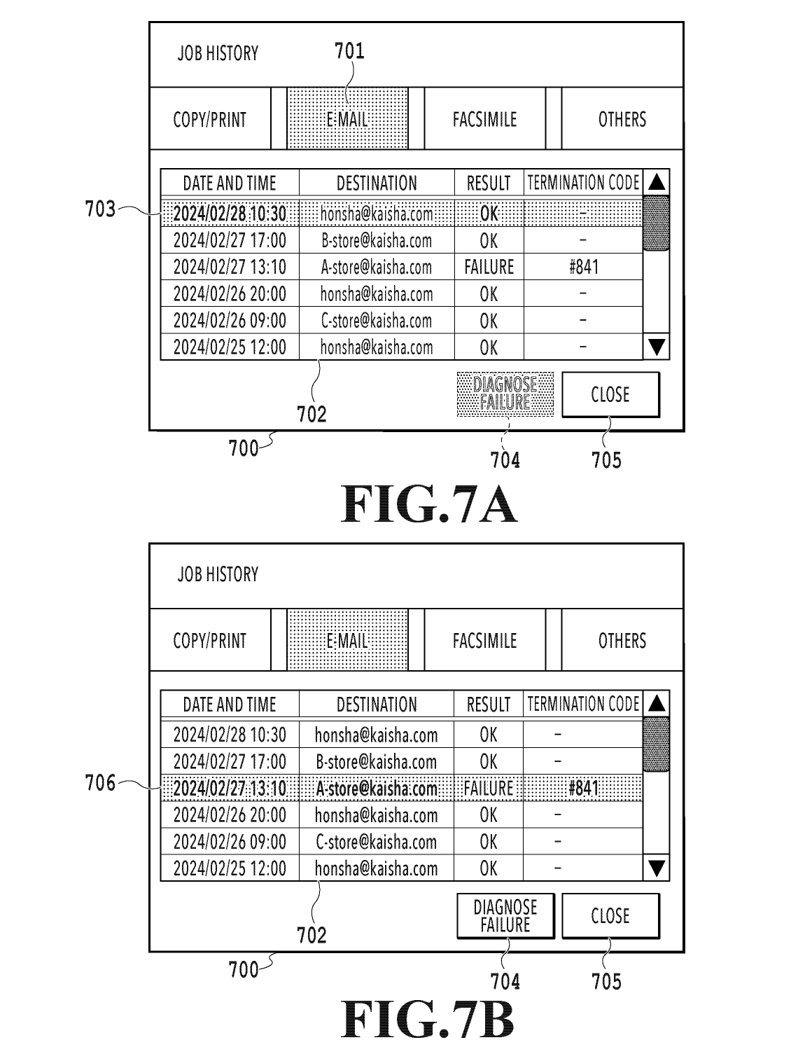

A transmission result and a termination code 521 at the termination are displayed on the termination screen 520. The termination code 521 is a number assigned to each cause of transmission failure, and "#841" is displayed in this case. Information on the executed job can be confirmed with reference to a job history. The user can cause the screen to transition to a job history screen 700 illustrated in FIG. 7A by pressing a job history button 523. In a case where the user presses a close button 522 in this situation, the CPU 201 closes the termination screen 520, and displays the scan-to-mail setting screen 504 on the operation unit 102.

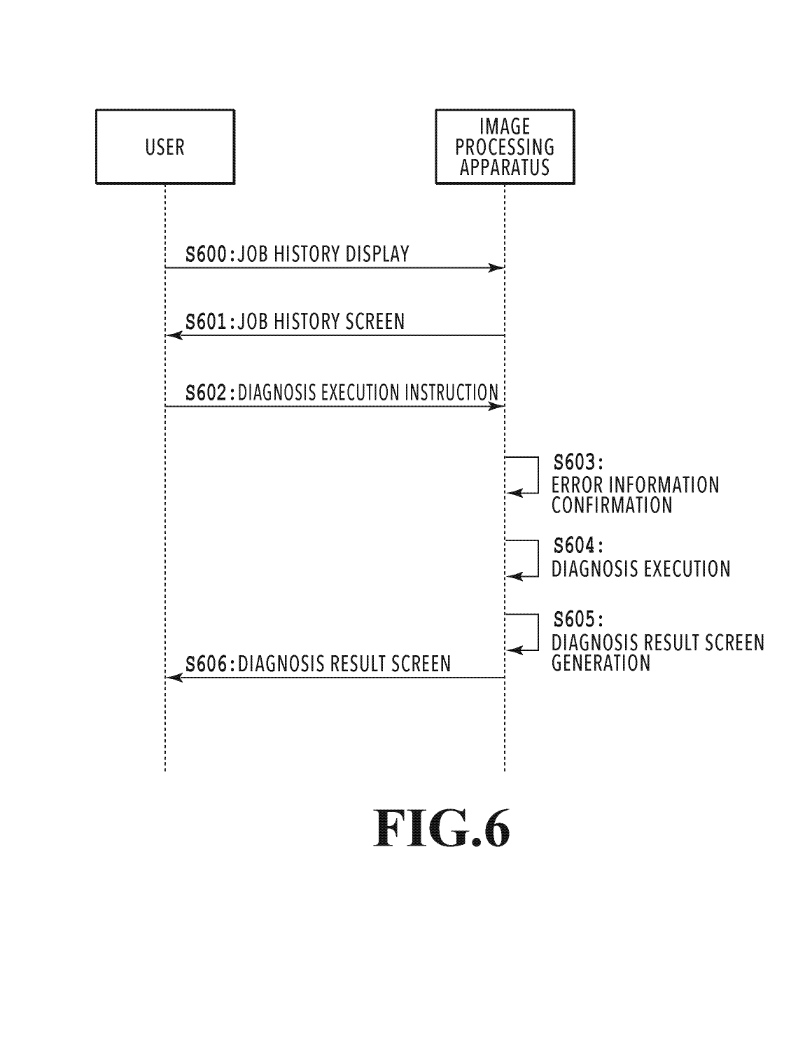

FIG. 6 is a sequence chart in which the image processing apparatus 100 selects a job to be diagnosed from the job history, and performs diagnosis through the diagnosis unit 309. Moreover, the CPU 201 implements each of processes in the sequence chart of FIG. 6 by expanding a program stored in the flash ROM 210 onto the DRAM 202 and executing the program. In S600, the user presses the job history button 523 of the termination screen 520 displayed in S412 or a job history button 502 of the home screen 500 to start a sequence of displaying the job history.

In S601, the CPU 201 displays the job history screen 700 illustrated in FIG. 7A. The display of the job history screen 700 can be switched for each job, and in a case where an e-mail button 701 is selected, the image processing apparatus 100 displays a job history list 702 of e-mail transmission. The job history list 702 includes date and time, destination, result, and termination code. Although the job histories are displayed in descending order of date and time from the latest job history in FIG. 7A, the present disclosure is not limited to this. The job histories may be displayed in ascending order of date and time from the oldest job history. In this case, for example, assume that the user selects a job history 703 whose date and time is "2024/02/28 10:30", whose destination is "honsha@kaisha.com", whose result is "OK", and whose termination code is "-". Since the job history 703 is not a history of a job whose result is failed, a failure diagnosis button 704 is grayed out and is unselectable. The failure diagnosis button 704 can be pressed only in a case where a job whose result is "failed" is selected. Moreover, in a case where the user presses a close button 705, the CPU 201 closes the job history screen 700, and displays the home screen 500 on the operation unit 102.

In S602, the user selects a job history 706 illustrated in FIG. 7B whose date and time are "2024/02/27 13:10", whose destination is "A-store@kaisha.com", whose result is "failed", and whose termination code is "#841", and presses the failure diagnosis button 704. In a case where the failure diagnosis button 704 is pressed, a diagnosis execution instruction is issued to the CPU 201 of the image processing apparatus 100.

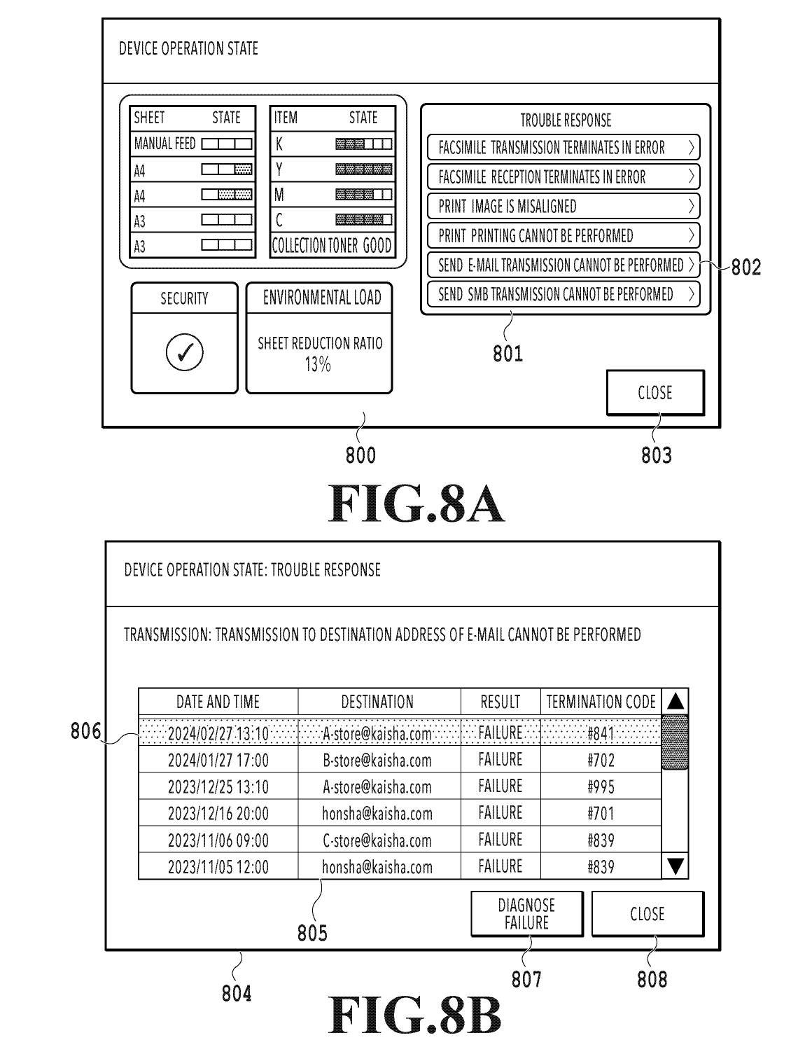

The diagnosis execution instruction can be issued from screens other than the job history screen 700. In a case where the user presses a device operation state button 503 on the home screen 500 illustrated in FIG. 5A, the CPU 201 displays a device operation state screen 800 illustrated in FIG. 8A. The device operation state screen 800 is a screen displaying a state of the image processing apparatus 100. The device operation state screen 800 includes a trouble response region 801 corresponding to the diagnosis of job relating to the present embodiment. In a case where the user presses details of trouble desired to be diagnosed, for example, a button 802 for "e-mail cannot be transmitted", the CPU 201 displays an e-mail transmission trouble response screen 804 illustrated in FIG. 8B. In a case where the user presses a close button 803 on the device operation state screen 800, the CPU 201 closes the device operation state screen 800, and displays the home screen 500 on the operation unit 102.

The e-mail transmission trouble response screen 804 includes an e-mail failure job history list 805 of failed e-mail transmission, a diagnosis button 807, and a close button 808. The e-mail failure job history list 805 includes date and time, destination, result, and termination code. Although e-mail failure job histories are displayed in descending order of date and time from the latest e-mail failure job history, the present disclosure is not limited to this. The e-mail failure job histories may be displayed in ascending order of date and time from the oldest e-mail failure job history. In a case where the user presses the close button 808 on the e-mail transmission trouble response screen 804, the CPU 201 closes the e-mail transmission trouble response screen 804, and displays the device operation state screen 800 on the operation unit 102. For example, the user selects a job history 806 whose date and time are "2024/02/27 13:10", whose destination is "A-store@kaisha.com", whose result is "failed", and whose termination code is "#841", and presses the diagnosis button 807. In a case where a user operation on the diagnosis button 807 is received, the diagnosis execution instruction same as that in S602 is issued to the CPU 201.

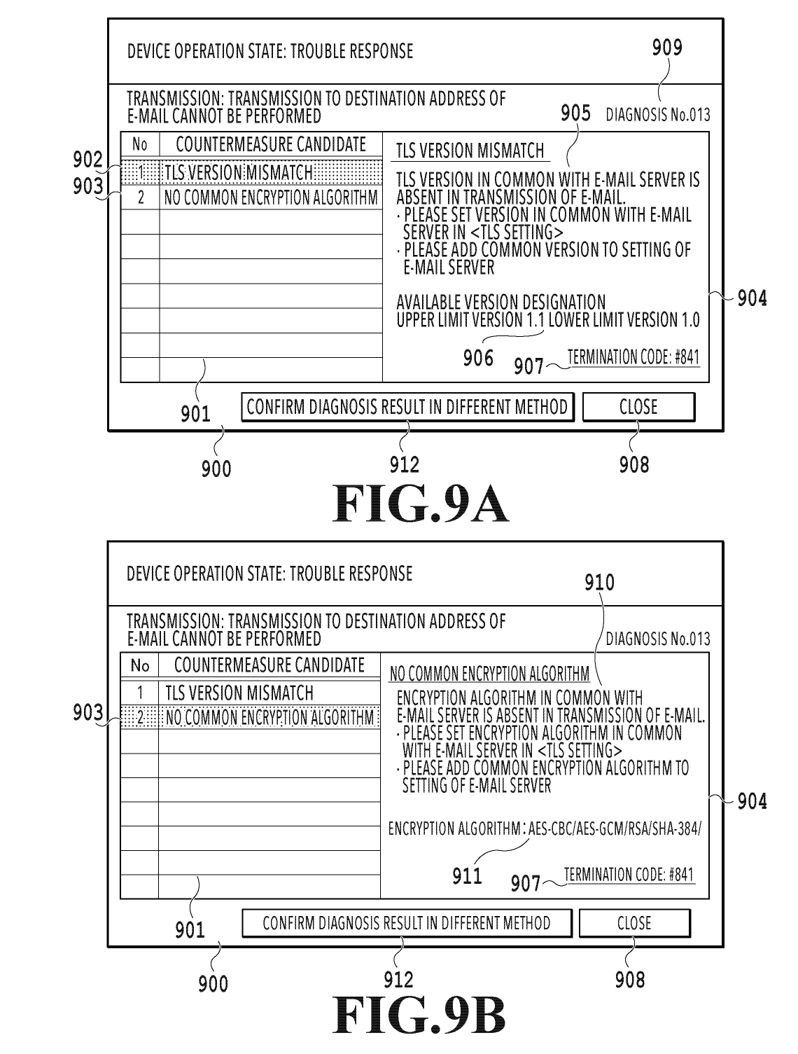

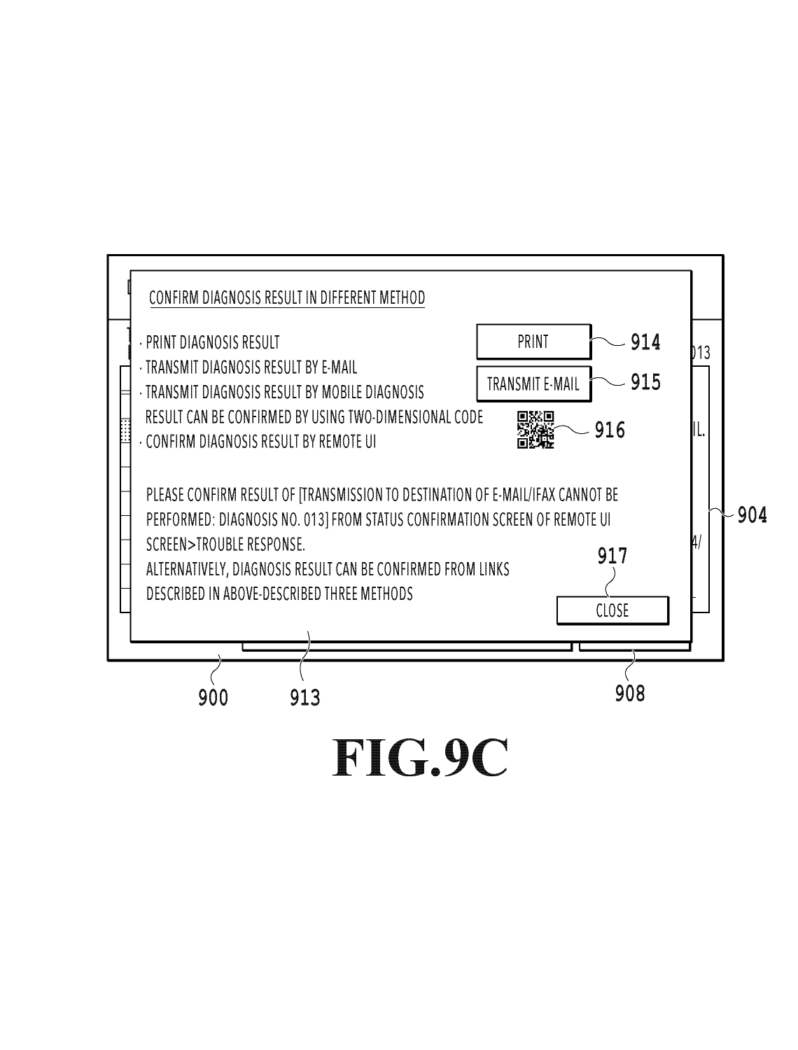

In S603, in a case where the CPU 201 receives the diagnosis execution instruction, the CPU 201 confirms the error information stored in S411. In S604, the CPU 201 diagnoses the job whose error information is confirmed. In S605, in a case where the diagnosis is completed, the CPU 201 generates a diagnosis result screen. In S606, the CPU 201 displays a diagnosis result screen 900 as illustrated in FIG. 9A on the operation unit 102. In a case where the diagnosis result screen 900 is displayed on the operation unit 102, the process of the sequence chart illustrated in FIG. 6 is terminated.

FIG. 9A is a screen displaying the diagnosis result of the job selected by the user in S602. The diagnosis result screen 900 includes a cause candidate list 901, countermeasure details 904, and a region 909 illustrating a number "diagnosis No. 013" for the diagnosis result. FIG. 9A is a screen in a case where a countermeasure candidate 902 for "TLS version mismatch" is selected from the cause candidate list 901. In this case, a countermeasure instruction 905 corresponding to the selected countermeasure candidate, a relating setting 906 of the image processing apparatus 100, and a termination code 907 of the selected job are displayed in the countermeasure details 904.

In a case where the user selects a countermeasure candidate 903 for "no common cryptographic algorithm" in this situation, the CPU 201 displays a screen in which the details of the countermeasure details 904 are changed to that illustrated in FIG. 9B. A countermeasure instruction 910, a setting 911 relating to the countermeasure, and the termination code 907 of the selected job are displayed in the countermeasure details 904. A two-dimensional code such as QR code (registered trademark) that is a link to a manual may be displayed in the countermeasure details 904 in addition to the details described above.

In a case where the user presses a close button 908 on the diagnosis result screen 900, the CPU 201 closes the diagnosis result screen 900, and displays the home screen 500 on the operation unit 102. The user can thereby confirm the details displayed in the countermeasure details 904, and perform troubleshooting by executing countermeasures such as setting change.

Moreover, in a case where the user presses a confirmation-in-different-method button 912, the CPU 201 displays a confirmation-in-different-method screen 913 illustrated in FIG. 9C. As methods of confirming the diagnosis result other than on the operation screen of the image processing apparatus 100, the present example presents printing, e-mail transmission, and mobile confirmation of the diagnosis result, and confirmation of the diagnosis result on the remote UI 131. However, the methods of confirming the diagnosis result may include other methods.

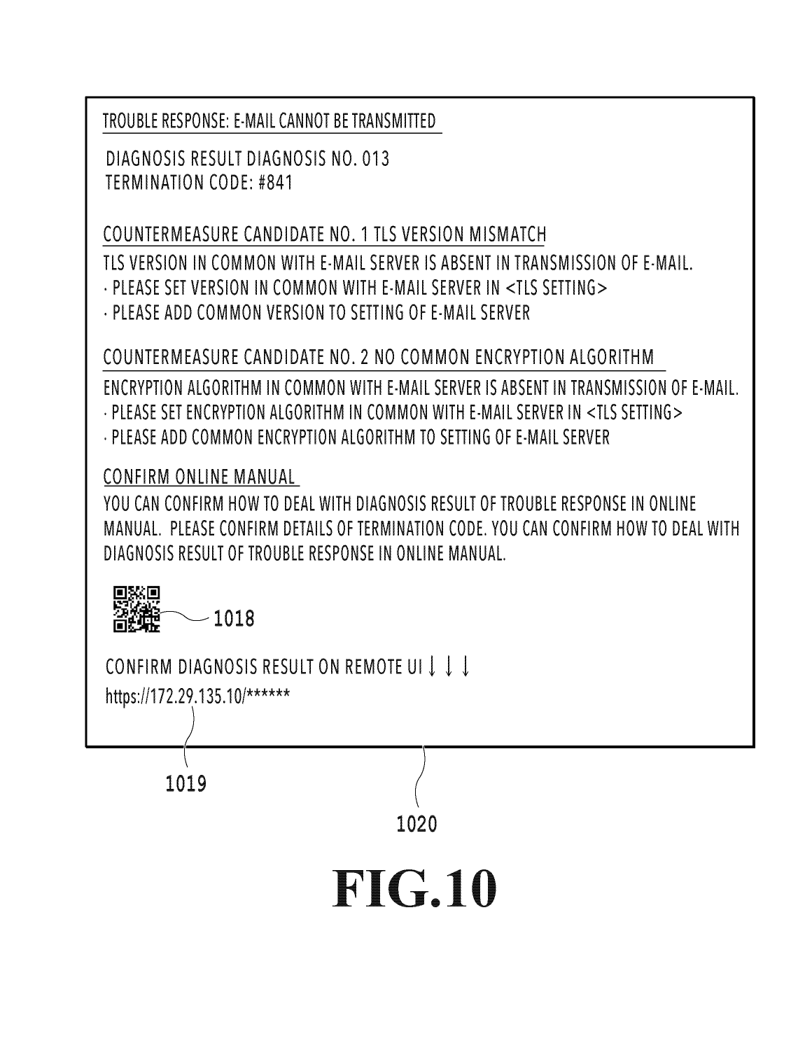

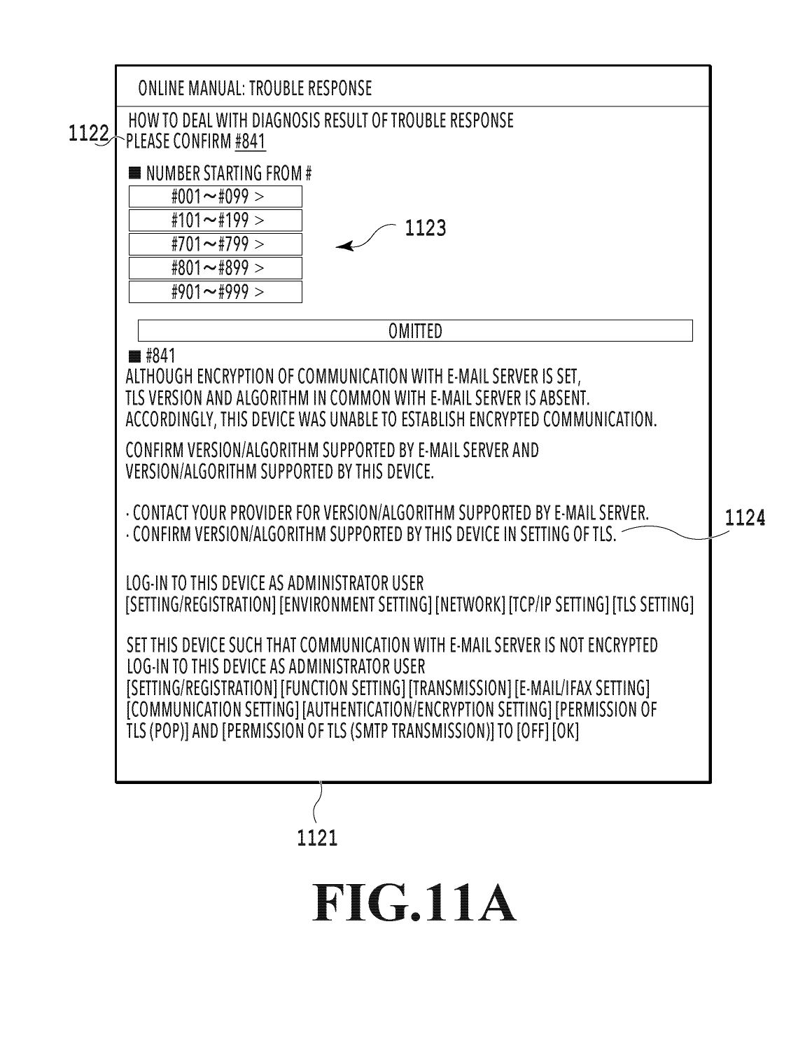

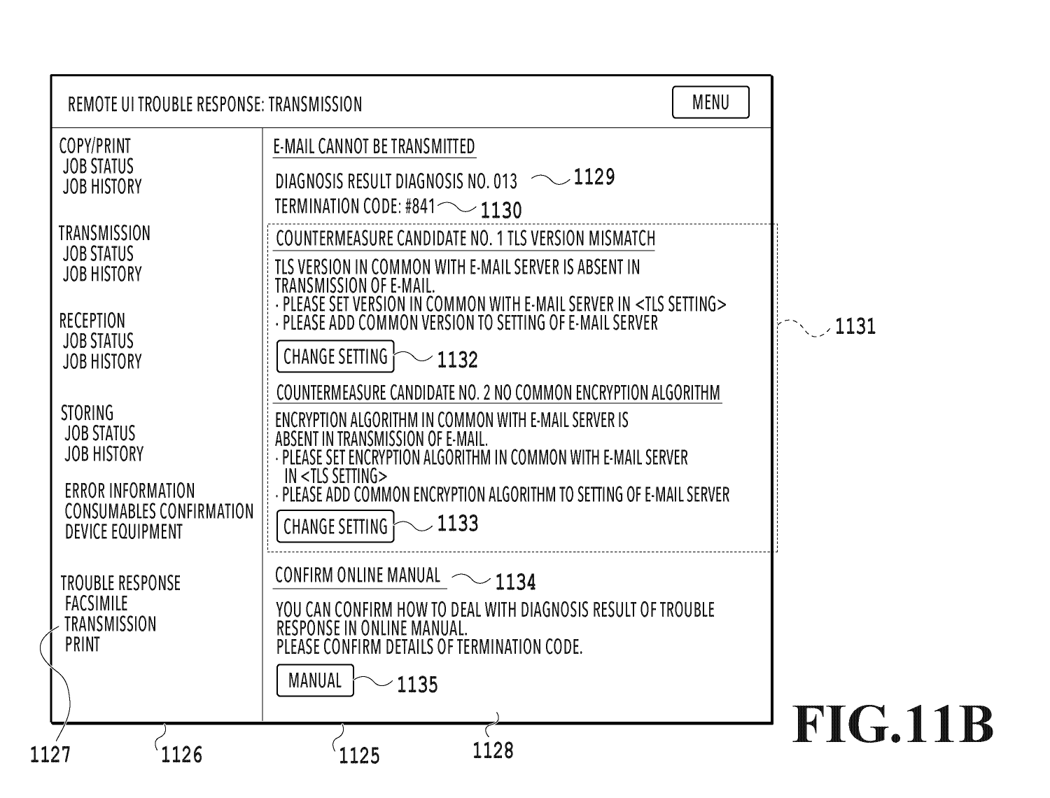

In a case where the user presses a print button 914, the image processing apparatus 100 prints diagnosis result data 1020 illustrated in FIG. 10. The user can read a manual two-dimensional code 1018 such as a manual QR code with a terminal such as a mobile terminal to access a trouble response manual screen 1121 illustrated in FIG. 11A from the terminal used for the reading and confirming a manual. The trouble response manual screen 1121 describes countermeasure details for each termination code, and includes a number 1122 of the termination code to be confirmed, a termination code index 1123, and countermeasure details 1124 for the termination code. In a case where the trouble response manual screen 1121 is opened from the diagnosis result data 1020 illustrated in FIG. 10, "#841" that is the same as the termination code 907 illustrated in FIG. 9A is displayed in the number 1122 of the termination code to be confirmed. The user selects the termination code index 1123 "#801 to #899" based on "#841", and further performs an operation of displaying the countermeasure details 1124 corresponding to "#841". The same information as the countermeasure details 904 may be described in the countermeasure details 1124, or countermeasure details not described in the countermeasure details 904 may be additionally described.

Moreover, the user can access a situation confirmation screen 1125 of the remote UI 131 illustrated in FIG. 11B from a URL described in a remote UI access URL 1019 illustrated in FIG. 10, and confirm the diagnosis result. Here, URL is an abbreviation of uniform resource locator. The situation confirmation screen 1125 includes a situation confirmation menu screen 1126 and a diagnosis result screen 1128. FIG. 11B illustrates the diagnosis result screen 1128 of transmission 1127 of trouble response in the situation confirmation menu screen 1126, and the diagnosis result screen 1128 is the same as the diagnosis result illustrated in FIGS. 9A and 9B. The diagnosis result screen 1128 includes a diagnosis No. 1129, a termination code 1130, countermeasure details 1131, and a guide-to-manual 1134.

Moreover, in a case where the user desires to perform a countermeasure candidate No. 1 described in the countermeasure details 1131, for example, change <TLS setting> of the image processing apparatus 100, the user presses a setting change button 1132. In a case where pressing of the setting change button 1132 by a user operation is received, the remote UI 131 transitions to a remote UI setting screen (not illustrated) in which the user can perform a corresponding setting change operation. In a case where the user desires to perform setting change described in a countermeasure candidate No. 2, the user similarly presses a setting change button 1133, and then the remote UI 131 transitions to a remote UI setting screen (not illustrated) in which the user can perform a corresponding setting change operation. In a case where the user desires to confirm an online manual, the user presses a manual button 1135. In a case where the manual button 1135 is pressed, the remote UI 131 newly opens the trouble response manual screen 1121 illustrated in FIG. 11A on a browser.

In a case where the user presses an e-mail transmission button 915 in FIG. 9C, the image processing apparatus 100 transmits diagnosis result data 1020 illustrated in FIG. 10 as e-mail data. The destination in this case is an e-mail address of the log-in user registered in advance. In a case of the e-mail transmission, a link may be included in the manual two-dimensional code 1018 such as the manual QR code. The remote UI access URL 1019 may also have a link form.

In FIG. 9C, a link with which the diagnosis result data 1020 generated by the image processing apparatus 100 and illustrated in FIG. 10 can be confirmed is embedded in a diagnosis result two-dimensional code 916. The user can confirm the diagnosis result by reading the diagnosis result two-dimensional code 916 with a terminal such as a mobile terminal. In this case, the manual two-dimensional code 1018 may include the link. The diagnosis result two-dimensional code 916 may be a two-dimensional code displayed on the screen or a printed two-dimensional code. Moreover, the remote UI access URL 1019 may have a link form. Furthermore, the web page presented based on this two-dimensional code may be provided by a web server in the image processing apparatus 100 or a separately-managed web server.

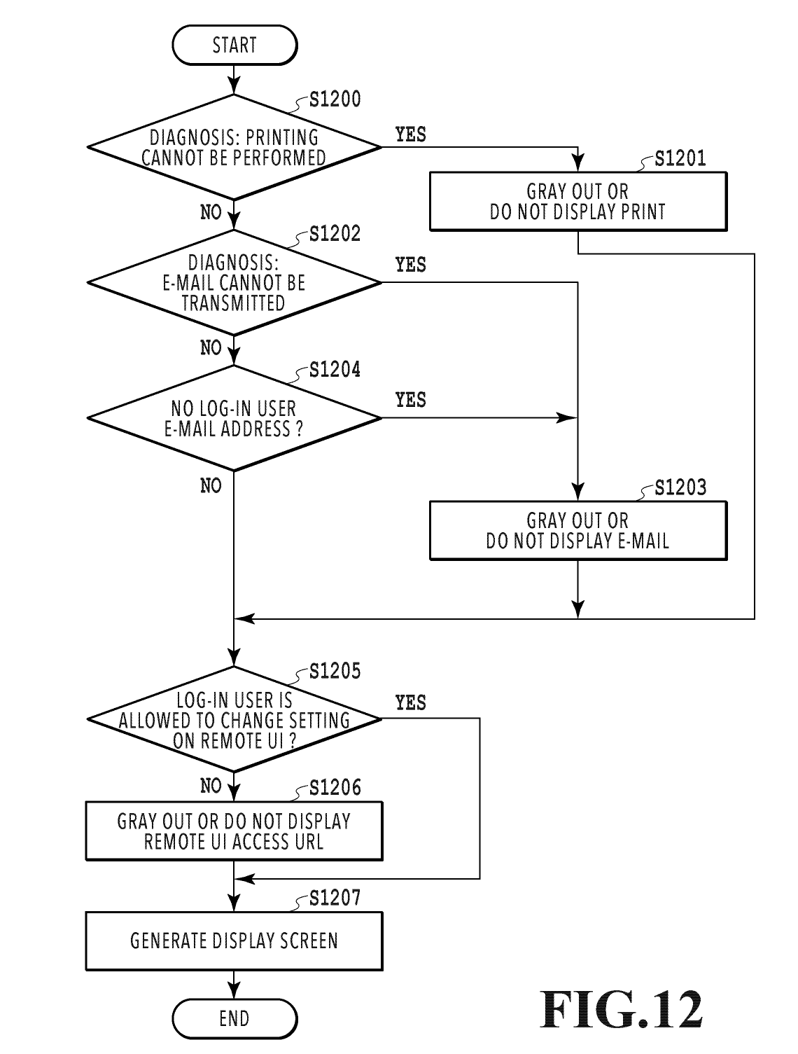

An operation in which, in a case where the internal diagnosis result is to be confirmed in a different method, display of the different method is controlled according to the user rights and the selected internal diagnosis in the present embodiment is explained in detail by using FIGS. 12 to 14. FIG. 12 is a flowchart of controlling display of different methods that can be selected from the confirmation-in-different-method screen 913, illustrated in FIG. 9C and displayed and controlled by the CPU 201 of the image processing apparatus 100, based predetermined conditions such as the internal diagnosis and the user rights. Moreover, the CPU 201 implements the processes in the flowchart of FIG. 12 by expanding a program stored in the flash ROM 210 onto the DRAM 202 and executing the program. Available methods at start of the flowchart of FIG. 12 are assumed to be "print", "e-mail transmission", "mobile confirmation", and "confirmation on remote UI".

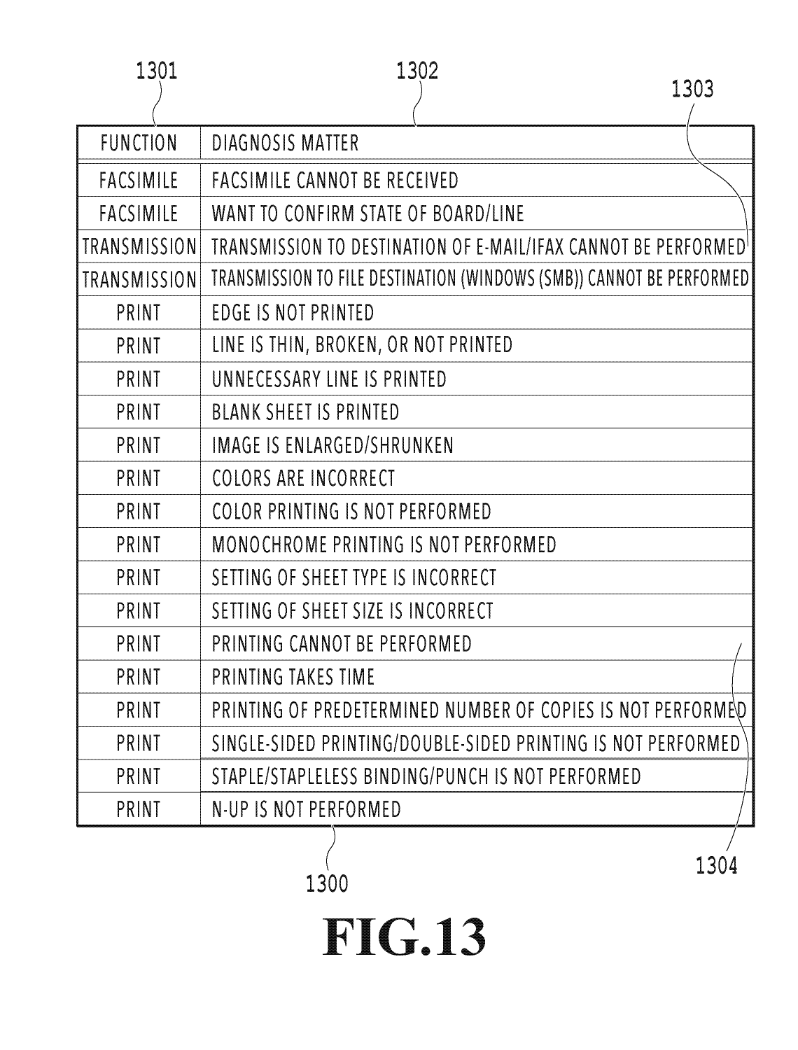

In S1200, the CPU 201 determines whether the diagnosis matter selected by the user is "printing cannot be performed" or not. In a case where the diagnosis matter is "printing cannot be performed", the process proceeds to S1201. In a case where the diagnosis matter is not "printing cannot be performed", the process proceeds to S1202. FIG. 13 illustrates an internal diagnosis matter list 1300 in which selection is to be performed by the user. The internal diagnosis matter list 1300 includes a function 1301 and a diagnosis matter 1302. The CPU 201 presents a list of matters desired to be diagnosed to the user in the trouble response region 801 illustrated in FIG. 8A, and the user selects a matter desired to be diagnosed from the presented list. In S1200, the CPU 201 determines whether the user has selected the function 1301 "print" and the diagnosis matter 1302 "printing cannot be performed" (region 1304). The internal diagnosis matter list 1300 may include other functions and other diagnosis matters. In a case where the diagnosis matter is "printing cannot be performed", the process proceeds to S1201. In a case where the diagnosis matter is not "printing cannot be performed", the process proceeds to S1202.

In S1201, the CPU 201 grays out or does not display the print button 914 displayed on the confirmation-in-different-method screen 913 illustrated in FIG. 9C, and the process proceeds to S1205. In S1202, the CPU 201 determines whether the diagnosis matter selected by the user is "e-mail cannot be transmitted" or not. In a case where the diagnosis matter is "e-mail cannot be transmitted", the process proceeds to S1203. In a case where the diagnosis matter is not "e-mail cannot be transmitted", the process proceeds to S1204.

In S1203, the CPU 201 grays out or does not display the e-mail transmission button 915 displayed on the confirmation-in-different-method screen 913 illustrated in FIG. 9C, and the process proceeds to S1205. In S1204, the CPU 201 determines whether the e-mail address of the log-in user is registered or not. In a case where the e-mail address of the log-in user is not registered, the process proceeds to S1203. In a case where the e-mail address of the log-in user is registered, the process proceeds to S1205.

In S1205, the CPU 201 determines whether the log-in user is allowed to change the setting on the remote UI 131. In a case where the log-in user is allowed to change the setting on the remote UI 131, the process proceeds to S1207. In a case where the log-in user is not allowed to change the setting on the remote UI 131, the process proceeds to S1206.

In S1206, the CPU 201 grays out or does not display a remote UI access URL 919 displayed on the confirmation-in-different-method screen 913 illustrated in FIG. 9C. In the remote UI 131, whether the access or the setting change is allowed or not is generally controlled according to the user rights. For example, there is a case where the user rights are set such that only the administrator is allowed to access the remote UI 131 and change the setting. In a case where the diagnosis result is confirmed on the remote UI 131, countermeasures such as the setting change are assumed to be performed directly after the confirmation. The remote UI is not suitable as the method to be displayed on the confirmation-in-different-method screen 913 for the user whose access to the remote UI 131 is limited or who is not allowed to change the setting through the remote UI 131. There may be other variations of the determination method in S1205.

In S1207, the CPU 201 generates the confirmation-in-different-method screen 913 illustrated in FIG. 9C, and terminates the process of the flowchart illustrated in FIG. 12. In a case where the CPU 201 generates the confirmation-in-different-method screen 913, the obtaining unit 310 obtains an available method from among "print", "e-mail transmission", "mobile confirmation", and "confirmation on remote UI", based on the process of the flowchart illustrated in FIG. 12. A method determined to be unavailable in the process of the flowchart of FIG. 12 displayed in a grayed-out manner or is not displayed on the confirmation-in-different-method screen 913, and the method obtained as the available method through the obtaining unit 310 is displayed in a selectable mode. The information providing unit 313 presents the diagnosis result of the error in a method selected by a user operation through the selection unit 312 on the confirmation-in-different-method screen 913.

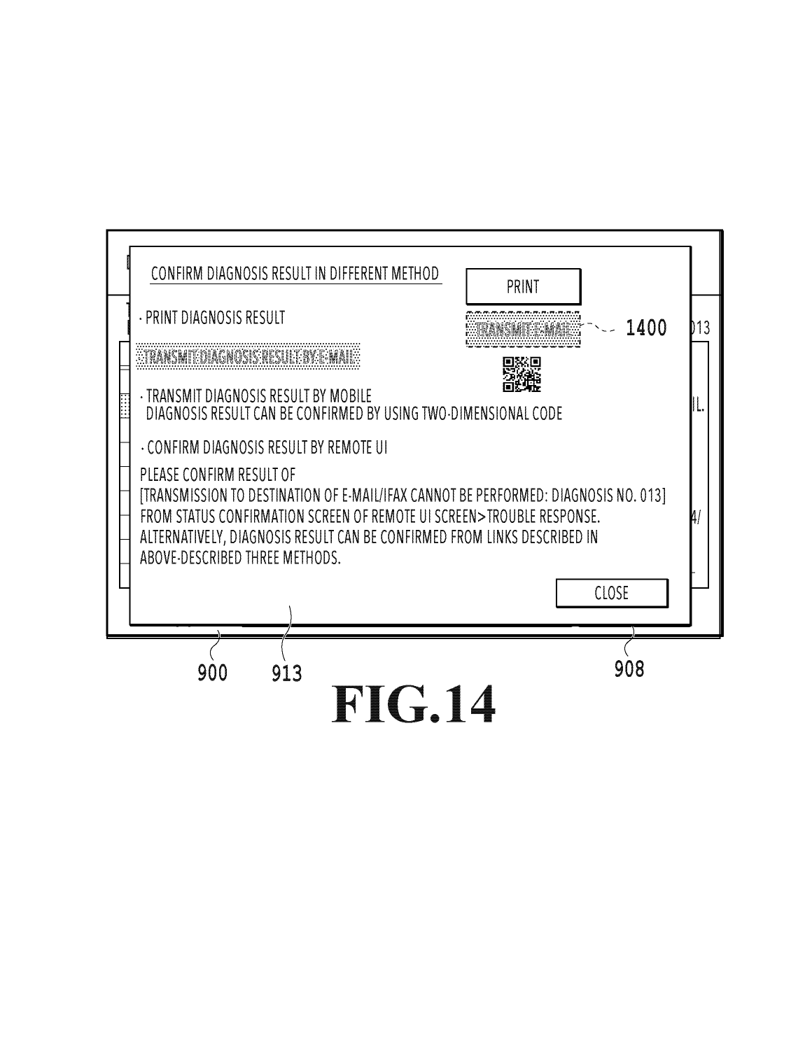

For example, FIG. 14 illustrates the confirmation-in-different-method screen 913 in a case where the "e-mail transmission" goes into the non-display mode in the confirmation method in S1203. In FIG. 14, an e-mail transmission button 1400 is grayed out to disable selection by the user.

As described above, screen display in a case where the diagnosis result of the image processing apparatus 100 is to be confirmed in a different method can be controlled depending on the user rights and the diagnosis matter selected by the user. Specifically, for the problem of "e-mail cannot be transmitted", "e-mail transmission" is grayed out or is not displayed in the methods of presenting the diagnosis result, and cannot be selected as the method of presenting the diagnosis result. This improves usability in the method of presenting the diagnosis result of the image processing apparatus.

### Second Embodiment

A second embodiment according to the present disclosure is explained below based on the drawings. In the present embodiment, explanation is given of an example in which, in a case where the internal diagnosis result is to be confirmed in a different method, the display in the different method is controlled while using a value set in the image processing apparatus 100.

In the first embodiment, explanation is given of the example in which, in a case where the internal diagnosis result is to be confirmed in the different method, display in the different method is controlled according to the user rights and the selected internal diagnosis. In the present embodiment, explanation is given of an example in which a setting of controlling whether to display the different method or not is provided individually for each of the different methods in the image processing apparatus 100, and the display in the different method is controlled also with reference to this setting.

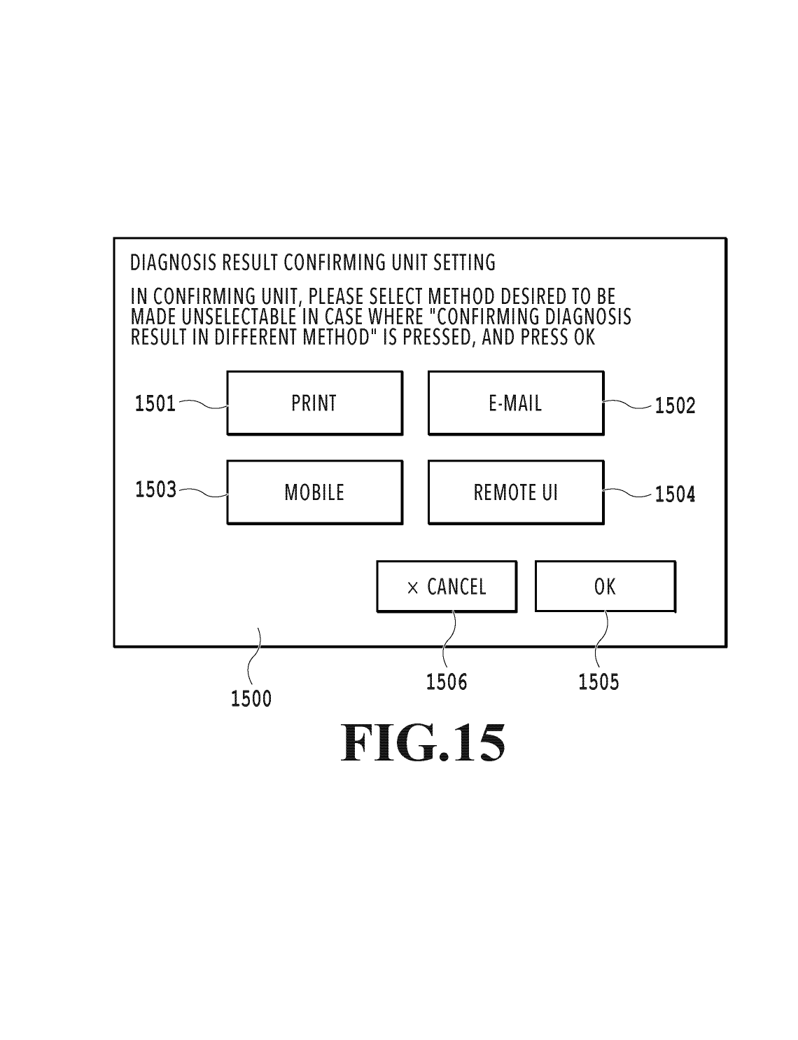

FIG. 15 illustrates a confirmation method setting screen 1500 of the internal diagnosis result of the image processing apparatus 100. The user selects a method desired not to be displayed on the confirmation-in-different-method screen 913 illustrated in FIG. 9C, and presses an OK button 1505. The CPU 201 of the image processing apparatus 100 disables selection of the above-selected method on the confirmation-in-different-method screen 913 through the method setting unit 314, irrespective of details of the internal diagnosis result and the user rights. In FIG. 15, a print 1501, an e-mail 1502, a mobile 1503, and a remote UI 1504 are in a selectable state on the confirmation-in-different-method screen 913. In a case where the user presses a cancel button 1506 on the confirmation method setting screen 1500, the CPU 201 closes the confirmation method setting screen 1500 without reflecting the setting.

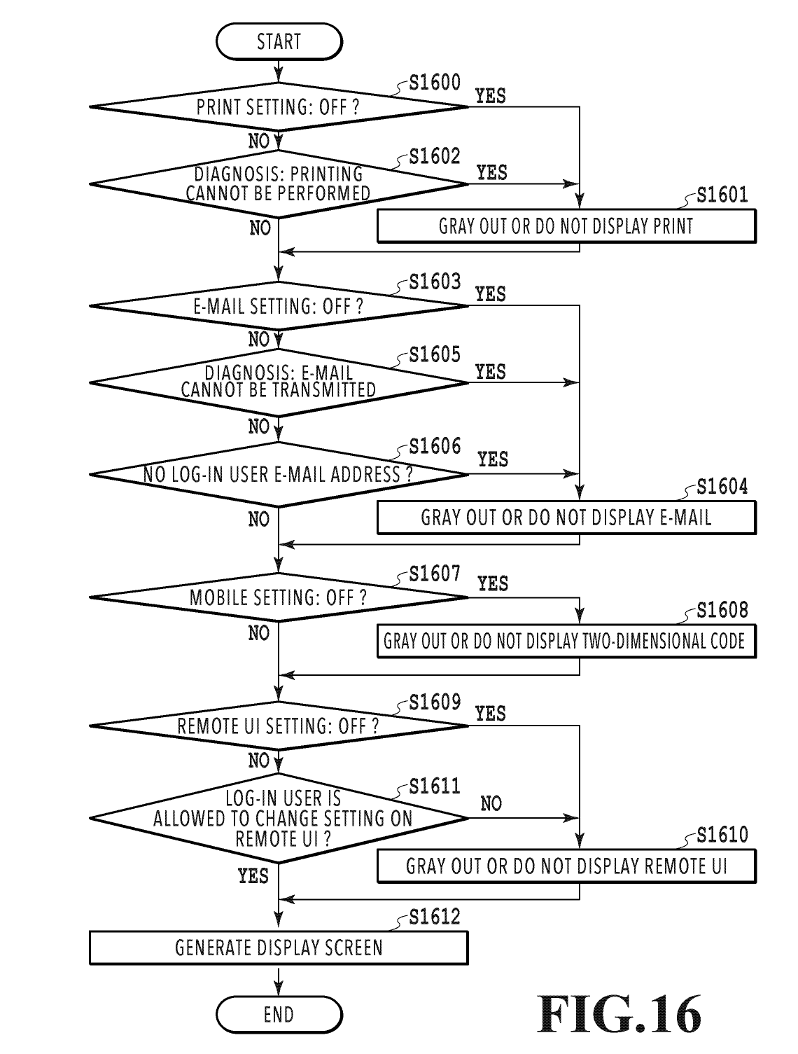

FIG. 16 is a flowchart in which the display of the confirmation-in-different-method screen 913 illustrated in FIG. 9C is controlled with the setting of the confirmation method setting screen 1500 also taken into consideration. Moreover, the CPU 201 implements the processes in the flowchart of FIG. 16 by expanding a program stored in the flash ROM 210 onto the DRAM 202, and executing the program. Available methods at start of the flowchart of FIG. 16 are assumed to be "print", "e-mail transmission", "mobile confirmation", and " confirmation on remote UI".

In S1600, the CPU 201 determines whether the print is set to OFF on the confirmation method setting screen 1500 or not. In a case where the print is set to OFF on the confirmation method setting screen 1500, the process proceeds to S1601. In a case where the print is not set to OFF on the confirmation method setting screen 1500, the process proceeds to S1602.

In S1601, the CPU 201 grays out or does not display "print" in the methods displayed on the confirmation-in-different-method screen 913. In S1602, the CPU 201 determines whether the diagnosis matter selected by the user is "printing cannot be performed" or not. In a case where the diagnosis matter is "printing cannot be performed", the process proceeds to S1601. In a case where the diagnosis matter is not "printing cannot be performed", the process proceeds to S1603.

In S1603, the CPU 201 determines whether the e-mail is set to OFF on the confirmation method setting screen 1500. In a case where the e-mail is set to OFF on the confirmation method setting screen 1500, the process proceeds to S1604. In a case where the e-mail is not set to OFF on the confirmation method setting screen 1500, the process proceeds to S1605.

In S1604, the CPU 201 grays out or does not display "e-mail transmission" in the methods displayed on the confirmation-in-different-method screen 913. In S1605, the CPU 201 determines whether the diagnosis matter selected by the user is "e-mail cannot be transmitted" or not. In a case where the diagnosis matter is "e-mail cannot be transmitted", the process proceeds to S1604. In a case where the diagnosis matter is not "e-mail cannot be transmitted", the process proceeds to S1606.

In S1606, the CPU 201 determines whether the e-mail address of the log-in user is registered or not. In a case where the e-mail address of the log-in user is not registered, the process proceeds to S1604. In a case where the e-mail address of the log-in user is registered, the process proceeds to S1607.

In S1607, the CPU 201 determines whether the mobile is set to OFF on the confirmation method setting screen 1500. In a case where the mobile is set to OFF on the confirmation method setting screen 1500, the process proceeds to S1608. In a case where the mobile is not set to OFF on the confirmation method setting screen 1500, the process proceeds to S1609.

In S1608, the CPU 201 does not display "two-dimensional code" (confirmation in mobile (user terminal)) in the methods displayed on the confirmation-in-different-method screen 913, and grays out or does not display a text referring to confirm using the two-dimensional code. In S1609, the CPU 201 determines whether the remote UI is set to OFF on the confirmation method setting screen 1500. In a case where the remote UI is set to OFF on the confirmation method setting screen 1500, the process proceeds to S1610. In a case where the remote UI is not set to OFF on the confirmation method setting screen 1500, the process proceeds to S1611.

In S1610, the CPU 201 grays out or does not display the remote UI access URL 919 in the methods displayed on the confirmation-in-different-method screen 913. In S1611, the CPU 201 determines whether the log-in user is allowed to change the setting on the remote UI 131. In a case where the log-in user is allowed to change the setting on the remote UI 131, the process proceeds to S1612. In a case where the log-in user is not allowed to change the setting on the remote UI 131, the process proceeds to S1610.

In S1612, the CPU 201 generates the confirmation-in-different-method screen 913 illustrated in FIG. 9C, and terminates the process of the flowchart illustrated in FIG. 16. In a case where the confirmation-in-different-method screen 913 is generated, the obtaining unit 310 obtains an available method from among "print", "e-mail transmission", "mobile confirmation", and "confirmation on remote UI", based on the process of the flowchart illustrated in FIG. 16. A method determined to be unavailable in the process of the flowchart of FIG. 16 is not displayed or displayed in a grayed-out manner on the confirmation-in-different-method screen 913, and the method obtained as the available method through the obtaining unit 310 is displayed in a selectable mode. The information providing unit 313 presents the diagnosis result of the error in a method selected by a user operation through the selection unit 312 on the confirmation-in-different-method screen 913.

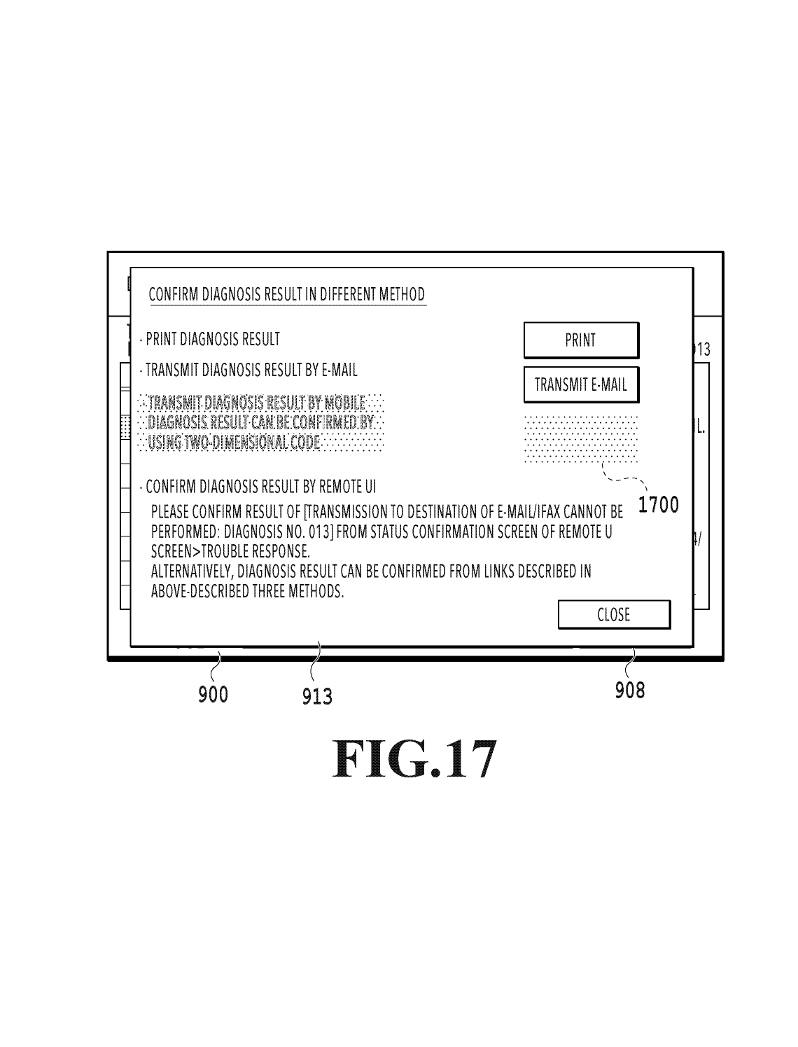

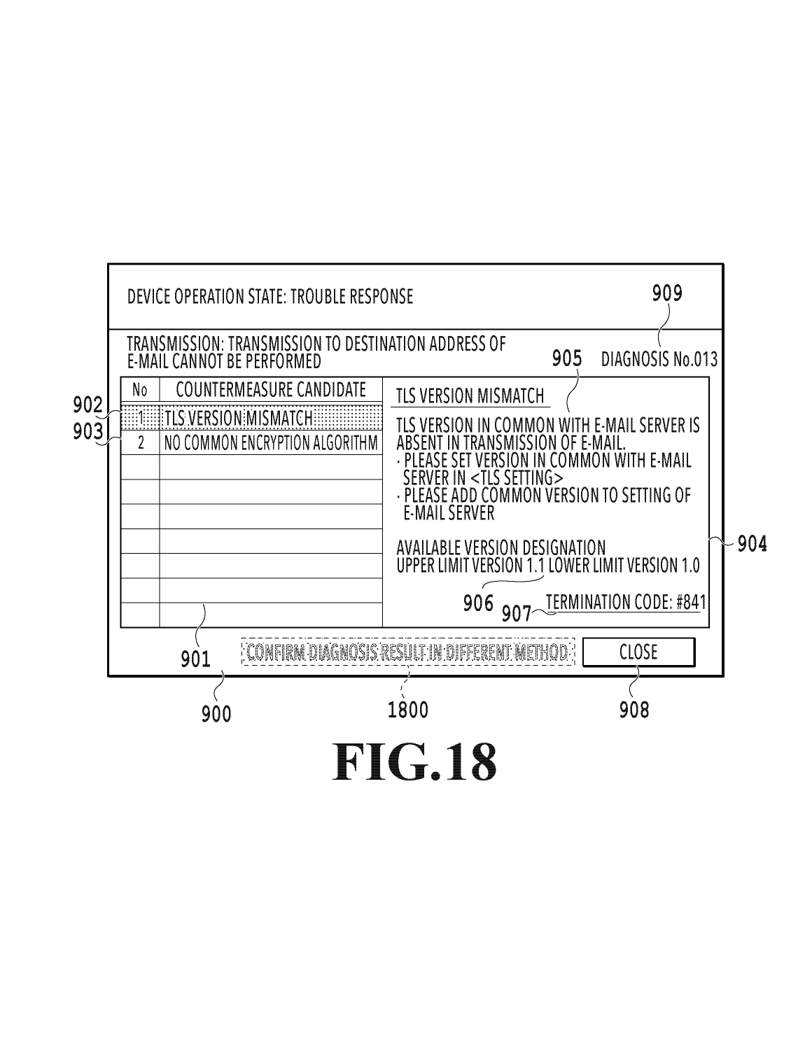

For example, in a case where "two-dimensional code" (confirmation in mobile) is not displayed in S1608, the confirmation-in-different-method screen 913 illustrated in FIG. 17 is displayed on the operation unit 102. A diagnosis result two-dimensional code 1700 is not displayed such that the user cannot refer to the diagnosis result two-dimensional code 1700, and a text referring to confirm using the two-dimensional code is grayed out. Moreover, in a case where all methods are not displayed as a result of executing the process of the flowchart, the CPU 201 sets a confirmation-in-different-method button 1800 of the diagnosis result screen 900 illustrated in FIG. 18 to a grayed-out state such that the confirmation-in-different-method button 1800 cannot be selected.

As described above, screen display in a case where the diagnosis result of the image processing apparatus is to be confirmed in a different method can be controlled with reference to not only the user rights and the diagnosis matter selected by the user but also the setting of whether the diagnosis result is to be confirmed in each of the different methods or not. This improves usability in the method of presenting the diagnosis result of the image processing apparatus.

### Third Embodiment

A third embodiment according to the present disclosure is explained below based on the drawings. Note that not all of features explained in the present embodiment are necessarily essential for the solving means of the present disclosure. In the present embodiment, explanation is given of an example in which the internal diagnosis result is confirmed on the remote UI 131 instead of the local UI. In the first embodiment, explanation is given of the example in which the display in the different method is controlled based on the user rights and the result of the selected internal diagnosis. In the present embodiment, explanation is given of an example in which confirmation of the internal diagnosis result on the remote UI 131 that is one of the different methods is executed without use of diagnosis result display on the local UI.

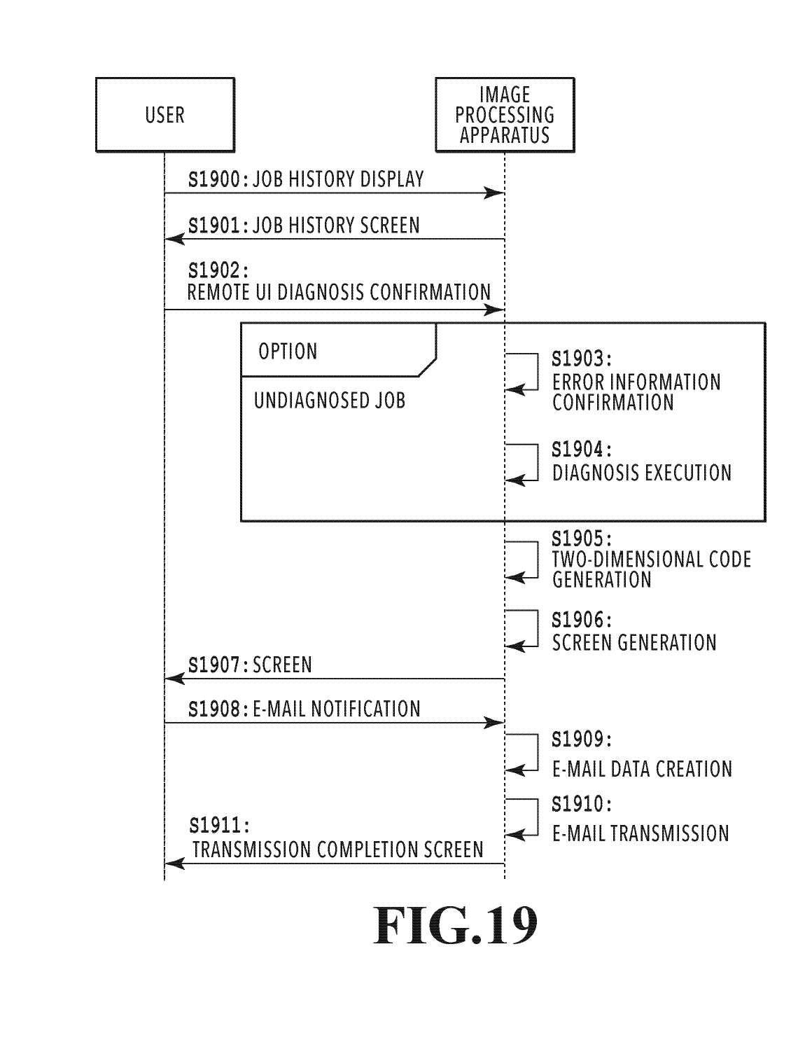

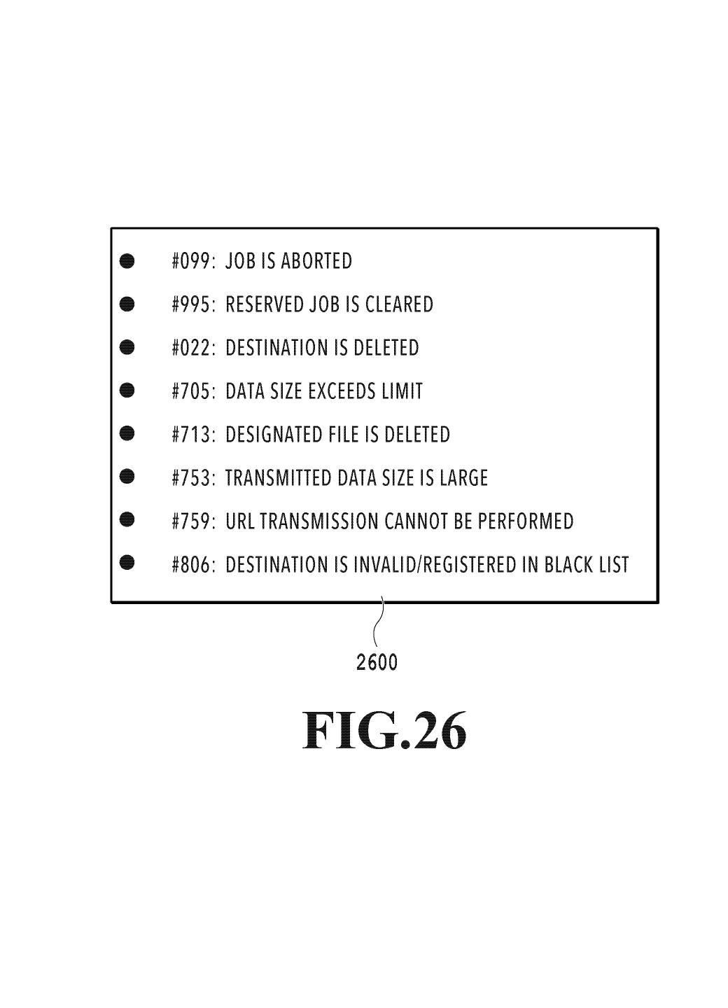

FIG. 19 is a sequence chart in which the image processing apparatus 100 selects a job for which the diagnosis result is to be confirmed on the remote UI 131 from the e-mail failure job history list, and controls two-dimensional code display and e-mail transmission for confirmation on the remote UI 131. In S1900, the button 802 for "e-mail cannot be transmitted" on the device operation state screen 800 illustrated in FIG. 8A is pressed by a user operation. In a case where the button 802 for "e-mail cannot be transmitted" is pressed, the CPU 201 receives a request of displaying job histories of jobs in which an error has occurred in the e-mail transmission. In an example explained below, a termination code of a selected job history is assumed to be "#099", and the error is assumed to be an e-mail transmission error occurring in a case where the job is aborted (see FIG. 26). Accordingly, the state of the image processing apparatus 100 is a state in which e-mail transmission from the image processing apparatus 100 is possible.

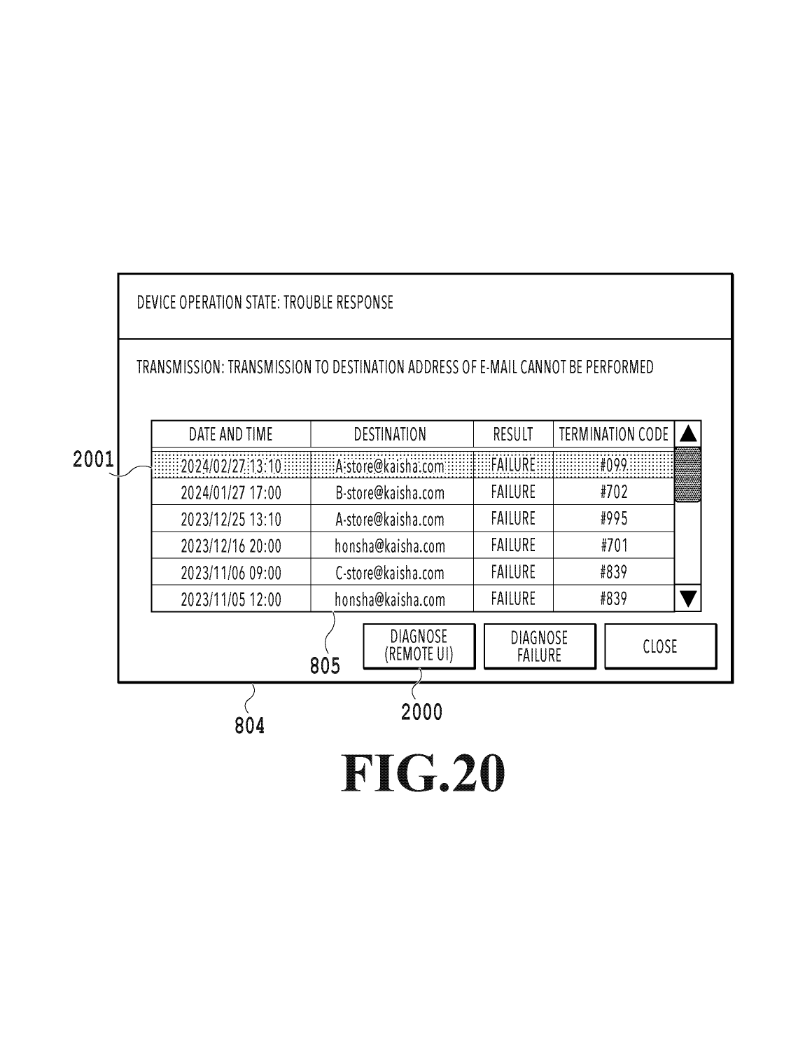

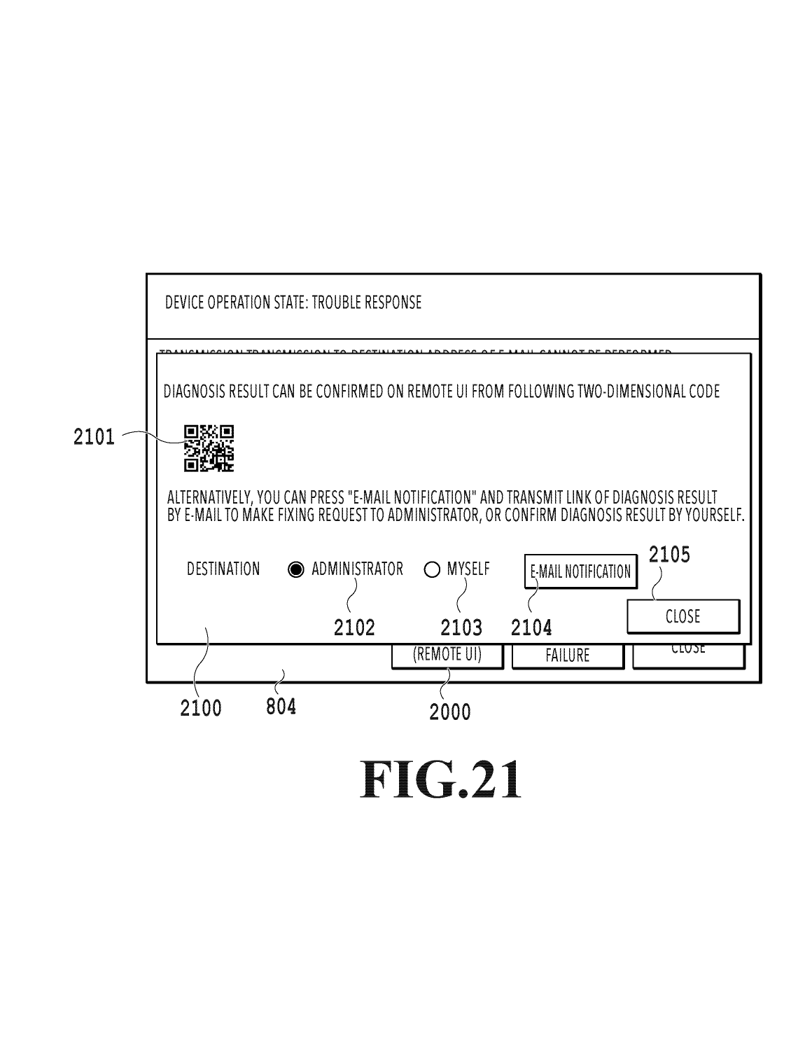

In S1901, the CPU 201 displays the e-mail transmission trouble response screen 804 including a job history screen (error history screen) of jobs in which an error has occurred in the e-mail transmission as illustrated in FIG. 20. The job history screen (error history screen) may be displayed for each type of error that has occurred. In S1902, for example, a job history 2001 is selected by a user operation on the e-mail transmission trouble response screen 804, and then a remote UI diagnosis button 2000 is pressed. In a case where the remote UI diagnosis button 2000 is pressed, the CPU 201 displays a remote UI confirmation guide screen 2100 illustrated in FIG. 21. In a case where the remote UI confirmation guide screen 2100 is displayed, the CPU 201 determines whether the selected job history 2001 has been already diagnosed or not. In a case where the selected job history 2001 is not diagnosed yet, processes of S1903 and S1904 are executed. In a case where the selected job history 2001 has been already diagnosed, the diagnosis result of the selected job has been already obtained, and thus the processes of S1903 and S1904 are not performed.

In S1903, the CPU 201 confirms the error information stored in S411. In S1904, the CPU 201 diagnoses the job whose error information is confirmed. In S1905, the CPU 201 generates a two-dimensional code 2101 for confirming the diagnosis result with the remote UI 131, based on the diagnosis result of the job. In S1906, the CPU 201 generates the remote UI confirmation guide screen 2100. In S1907, the CPU 201 displays the remote UI confirmation guide screen 2100. The user can access the situation confirmation screen 1125 of the remote UI 131 illustrated in FIG. 11B and confirm the diagnosis result by reading the two-dimensional code 2101 with a user terminal (mobile terminal) such as a smartphone or a tablet terminal or with a similar device.

Moreover, the user may transmit an e-mail in which a URL for confirming the diagnosis result on the remote UI 131 is described. In S1908, as illustrated in FIG. 21, the user selects an administrator 2102 as a destination from among radio buttons on the remote UI confirmation guide screen 2100, and then presses an e-mail notification button 2104. In a case where the e-mail notification button 2104 is pressed, the CPU 201 receives an e-mail notification request.

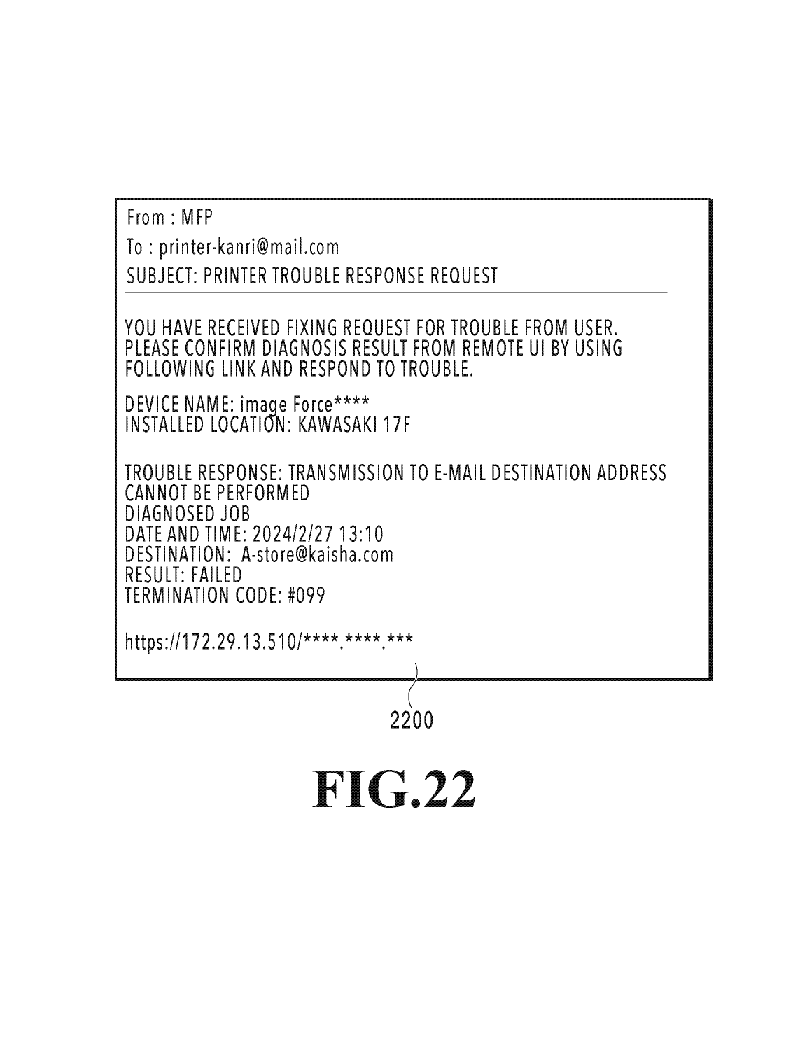

In S1909, the CPU 201 generates administrator response request e-mail data 2200 illustrated in FIG. 22. In S1910, the CPU 201 transmits an e-mail with the above-mentioned contents to the destination registered in the image processing apparatus 100 as the administrator. In S1911, in a case where the transmission of e-mail is completed, the CPU 201 displays a transmission completion screen (not illustrated).

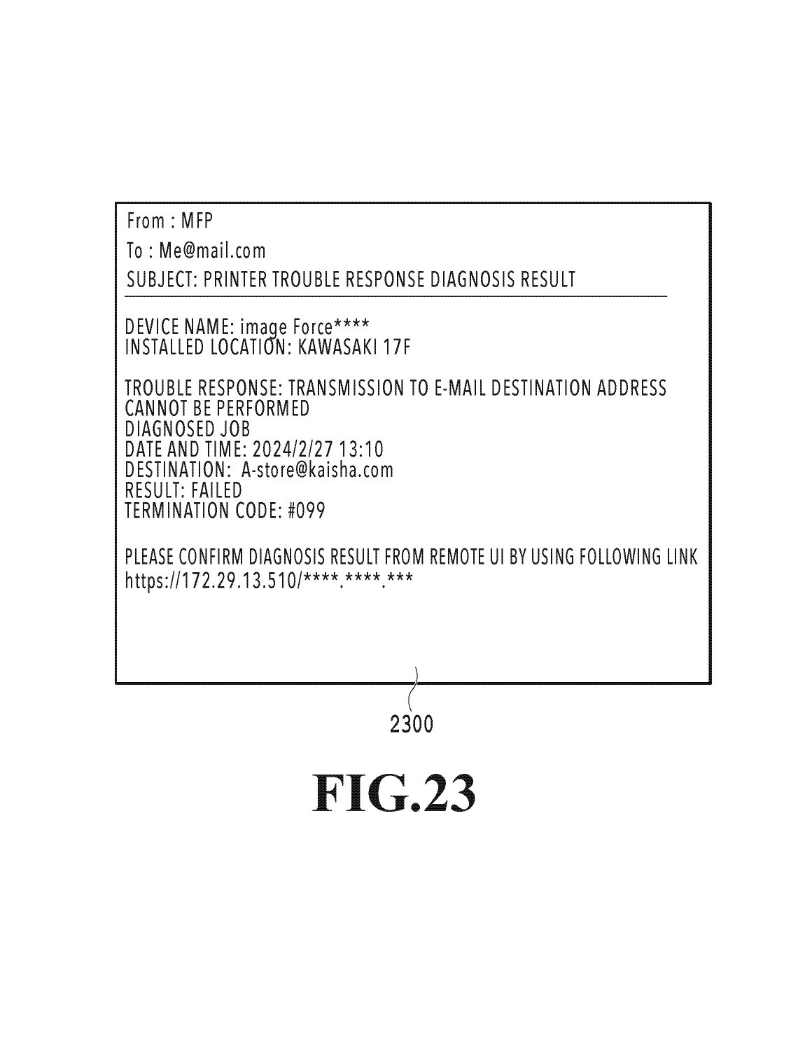

The user may select a myself 2103 as the destination from among the radio buttons on the remote UI confirmation guide screen 2100 illustrated in FIG. 21, and then press the e-mail notification button 2104. In a case where the e-mail notification button 2104 is pressed after the selection of the myself 2103 as the destination, the CPU 201 receives the e-mail notification request. The CPU 201 generates diagnosis result confirmation e-mail data 2300 illustrated in FIG. 23, and transmits an e-mail to the destination of the user registered in the image processing apparatus 100. A request for response from the described URL to the remote UI 131 can be notified to the administrator by transmitting the administrator response request e-mail data 2200 to the administrator, and then the administrator can handle the request. Moreover, the user can also confirm the diagnosis result by himself/herself from the URL described in the diagnosis result confirmation e-mail data 2300.

In a case where the user presses a close button 2105 on the remote UI confirmation guide screen 2100 illustrated in FIG. 21, the CPU 201 closes the remote UI confirmation guide screen 2100, and displays the e-mail transmission trouble response screen 804.

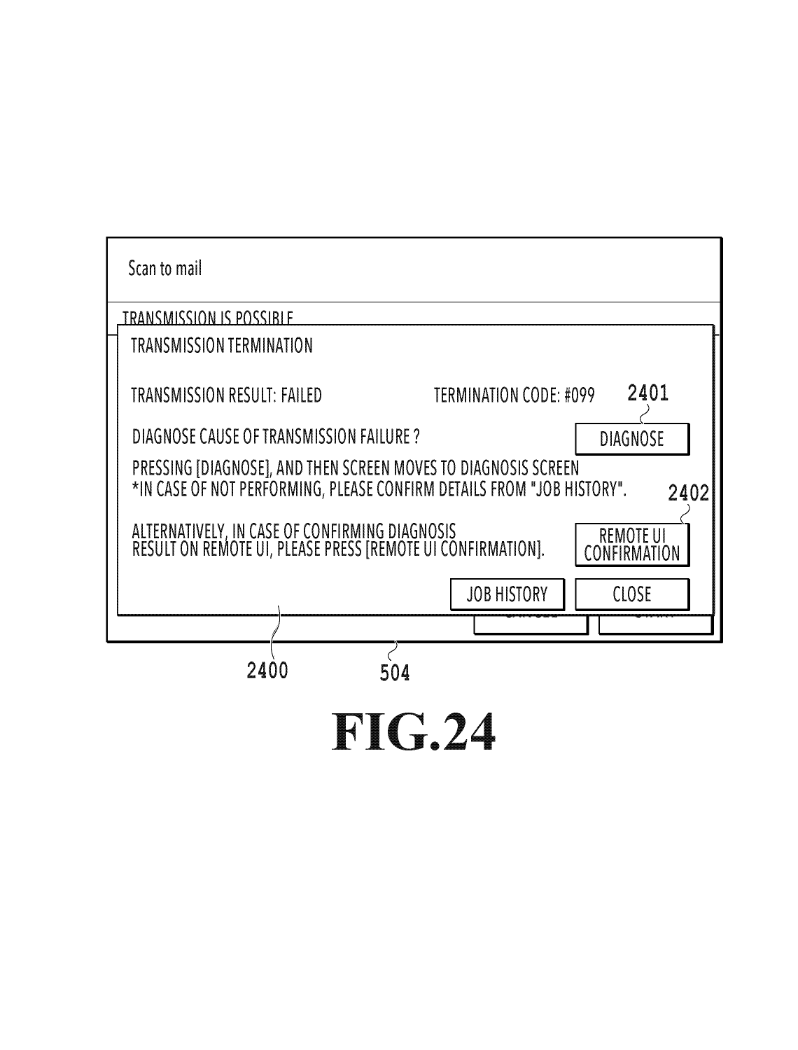

The display of the diagnosis result screen 900 and the remote UI c confirmation heck guide screen 2100 may be performed from a screen other than the e-mail transmission trouble response screen 804. The user presses the start button 510 on the scan-to-mail setting screen 504 illustrated in FIG. 24. In a case where the start button is pressed and the CPU 201 of the image processing apparatus 100 completes the e-mail transmission, the CPU 201 displays a transmission termination screen 2400. Unlike the termination screen 520, the transmission termination screen 2400 includes a remote UI confirmation button 2402 and a diagnosis button 2401 that enables transition to the diagnosis result screen 900 of the local UI.

In a case where the user presses the diagnosis button 2401, the CPU 201 performs the processes for execution of diagnosis described in S602 to S605, and displays the diagnosis result screen 900. Meanwhile, in a case where the user presses the remote UI confirmation button 2402, the CPU 201 performs the processes for execution of diagnosis described in S1903 to S1906, and displays the remote UI confirmation guide screen 2100. As described above, the CPU 201 of the image processing apparatus 100 can display the diagnosis result from the transmission termination screen 2400 and can also execute the process for confirming the diagnosis result on the remote UI 131.

### Fourth Embodiment

A fourth embodiment according to the present disclosure is explained below based on the drawings. Note that not all of features explained in the present embodiment are necessarily essential for the solving means of the present disclosure. In the present embodiment, explanation is given of an example in which, in a case where the internal diagnosis result is confirmed on the remote UI 131 by performing e-mail transmission, the image processing apparatus 100 controls the display in the different method by using e-mail transmission based on the result of the internal diagnosis and the user rights. In the third embodiment, explanation is given of the example in which the link for confirmation on the remote UI 131 is transmitted by e-mail without the display of the internal diagnosis result on the local UI. In the present embodiment, explanation is given of the example in which the image processing apparatus 100 controls the display in the different method by using e-mail transmission based on the internal diagnosis result and the user rights.

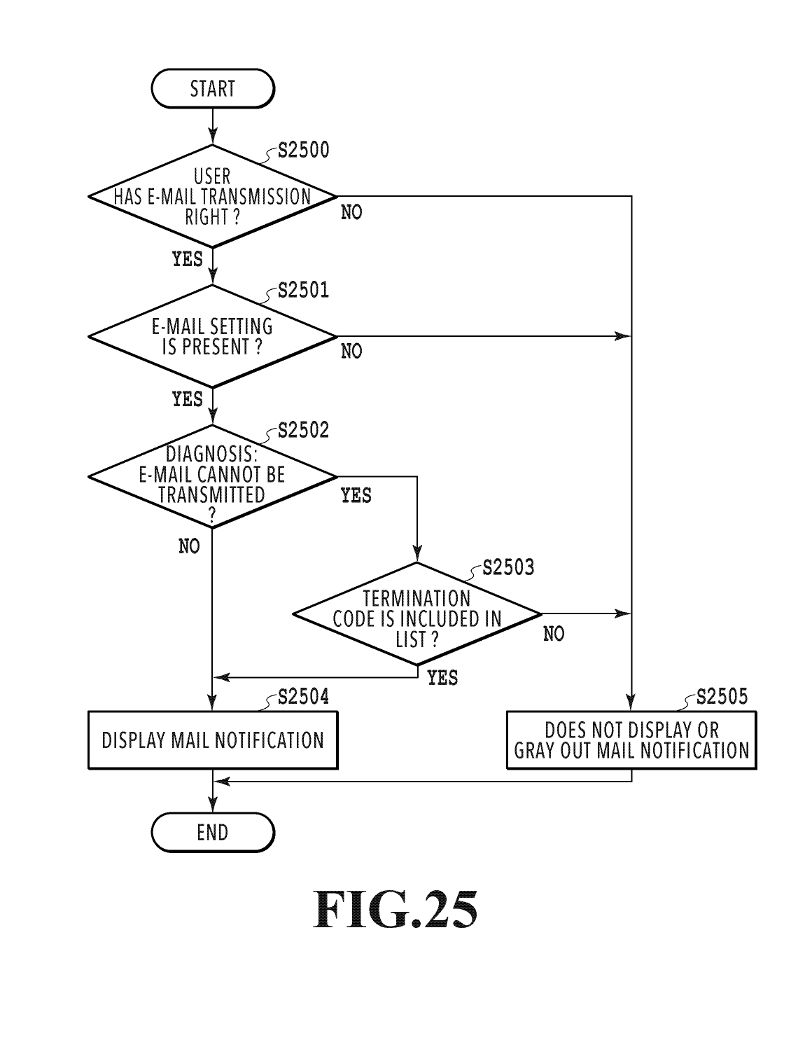

FIG. 25 is a flowchart in which the image processing apparatus 100 controls display of portions of the remote UI confirmation guide screen 2100 relating to e-mail transmission. Moreover, the CPU 201 implements the processes in the flowchart of FIG. 25 by expanding a program stored in the flash ROM 210 onto the DRAM 202 and executing the program.

In S2500, in a case where the CPU 201 receives the display instruction of the remote UI confirmation guide screen 2100 by the user operation, the CPU 201 determines whether the user has a right to transmit an e-mail. In a case where the user has the right to transmit an e-mail, the process proceeds to S2501. In a case where the user does not have the right to transmit an e-mail, the process proceeds to S2505.

In S2501, the CPU 201 determines whether there is setting necessary for e-mail transmission in the image processing apparatus 100. In a case where the setting necessary for e-mail transmission is made, the process proceeds to S2502. In a case where the setting necessary for e-mail transmission is not made, the process proceeds to S2505. The setting necessary for e-mail transmission is setting of the SMTP server address through which an e-mail is routed in e-mail transmission, a SMTP port number, a transmission source e-mail address, and the like, but may include other setting items.

In S2502, the CPU 201 determines whether the diagnosis matter selected by the user is "e-mail cannot be transmitted" or not. In a case where the diagnosis matter selected by the user is "e-mail cannot be transmitted", the process proceeds to S2503. In a case where the diagnosis matter selected by the user is not "e-mail cannot be transmitted", the process proceeds to S2504.

In S2503, the CPU 201 determines whether the termination code of the job to be diagnosed that is selected by the user is included in an e-mail transmission possible termination code list 2600 illustrated in FIG. 26. In a case where the termination code of the job to be diagnosed is included in the e-mail transmission possible termination code list 2600 illustrated in FIG. 26, the process proceeds to S2504. In a case where the termination code of the job to be diagnosed is not included in the e-mail transmission possible termination code list 2600 illustrated in FIG. 26, the process proceeds to S2505. Since the termination codes described in the e-mail transmission possible termination code list 2600 are not termination codes indicating that the e-mail transmission itself is impossible, the e-mail transmission possible termination code list 2600 is a list of termination codes indicating that transmission of e-mail for confirmation on the remote UI 131 is possible. The items of the e-mail transmission possible termination code list 2600 may include other items as long as contents of the items are such that the e-mail transmission itself is possible.

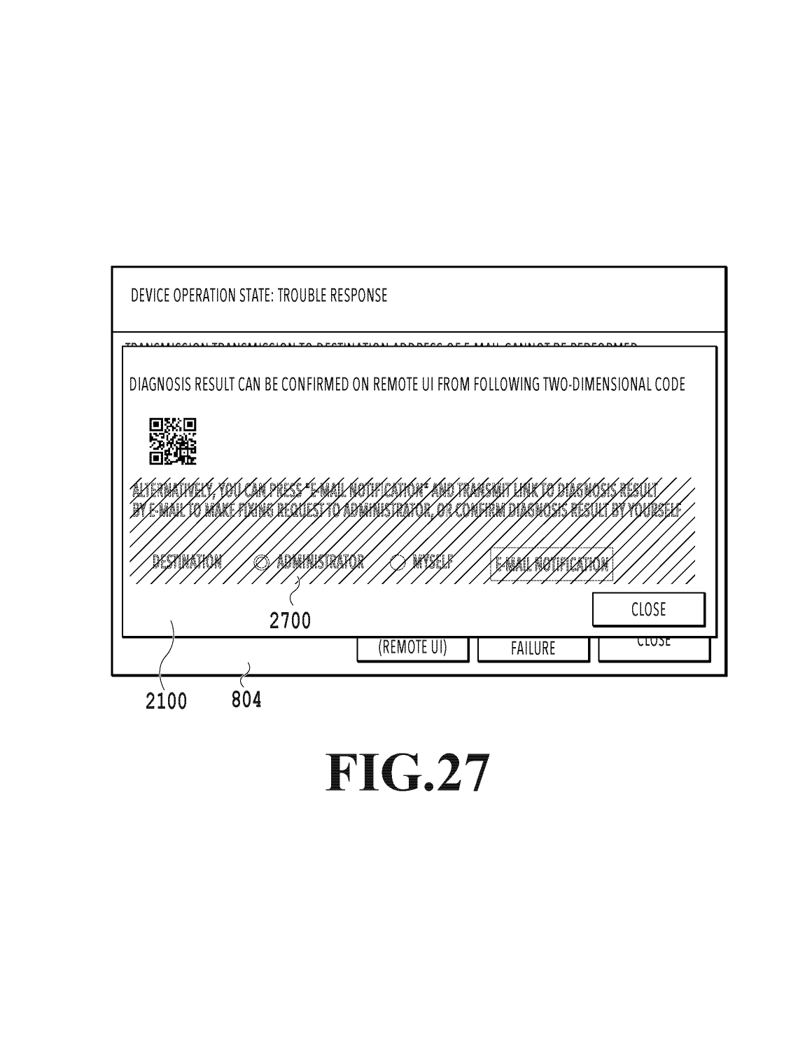

In S2504, the CPU 201 displays a portion relating to e-mail notification on the remote UI confirmation guide screen 2100, and the process of the flowchart illustrated in FIG. 25 is terminated. In S2505, the CPU 201 is not displayed or grays out a region 2700 of the remote UI confirmation guide screen 2100 relating to the e-mail notification as illustrated in FIG. 27, and the process of the flowchart illustrated in FIG. 25 is terminated.

As described above, the display in the different method can be appropriately controlled in a case where the image processing apparatus 100 is in a state where the image processing apparatus 100 cannot transmit the e-mail for confirmation on the remote UI 131.

### Fifth Embodiment

A fifth embodiment according to the present disclosure is explained below based on the drawings. Note that not all of features explained in the present embodiment are necessarily essential for the solving means of the present disclosure. In the present embodiment, explanation is given of an example in which, in a case where the user accesses the remote UI 131 with a user terminal (mobile terminal) such as a smartphone and confirms the internal diagnosis result, the diagnosis result is transmitted by e-mail.

In the third embodiment, explanation is given of the example in which the situation confirmation screen 1125 is displayed by reading the two-dimensional code with the user terminal (mobile terminal). In the present embodiment, explanation is given of an example in which, in a case where the situation confirmation screen 1125 is displayed on the user terminal (mobile terminal), a unit to transmit the diagnosis result details by e-mail is displayed.

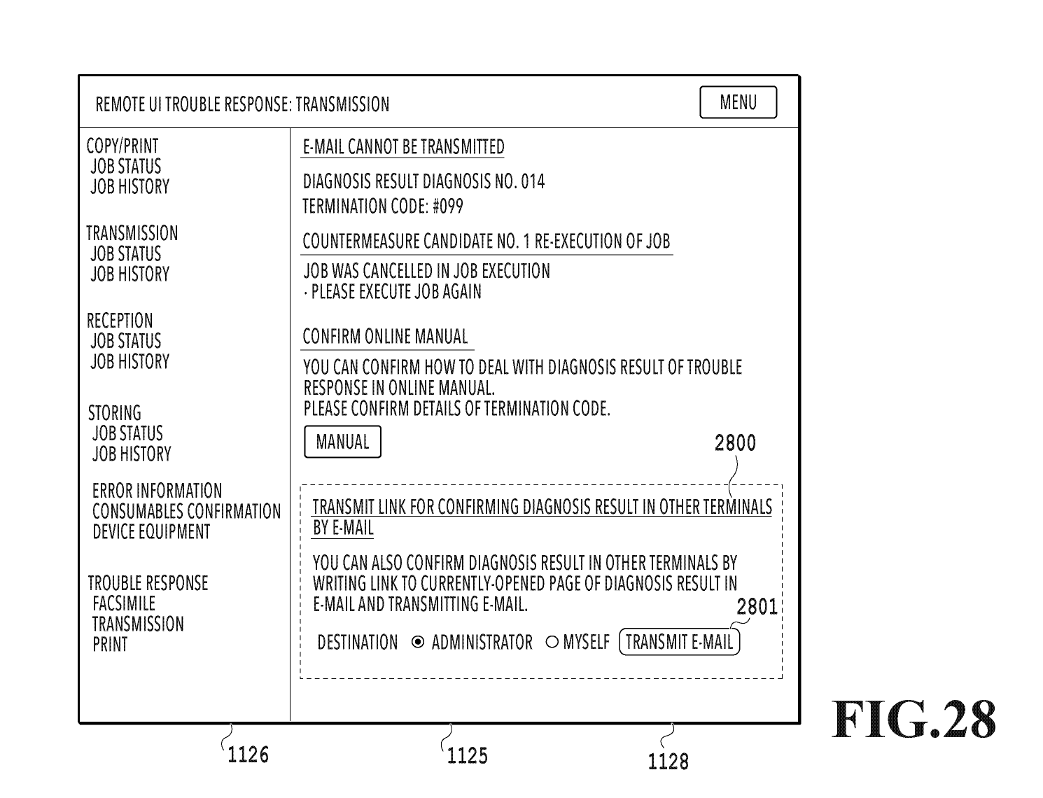

The user reads the two-dimensional code 2101 of the remote UI confirmation guide screen 2100 illustrated in FIG. 21 by using the user terminal (mobile terminal). In a case where the user accesses the remote UI 131, the remote UI 131 displays the situation confirmation screen 1125 illustrated in FIG. 28. In a case where the access source is the user terminal (mobile terminal), the remote UI 131 displays a region 2800 relating to the e-mail transmission of the diagnosis result. In a case where the user selects the administrator or the user himself/herself as the destination and presses an e-mail transmission button 2801, the remote UI 131 instructs the CPU 201 of the image processing apparatus 100 to perform e-mail transmission. The CPU 201 of the image processing apparatus 100 transmits an e-mail according to the instruction from the remote UI 131. This e-mail data is the same as the administrator response request e-mail data 2200 or the diagnosis result confirmation e-mail data 2300. This enables access to the same internal diagnosis result from the link described in the e-mail data.

As described above, the user can make a response request by transmitting the e-mail to the administrator even in a case where the diagnosis result is displayed on the user terminal (mobile terminal). Alternatively, the user can confirm the diagnosis result by opening the e-mail on another terminal with a larger screen size than the mobile terminal such as a tablet terminal or a PC and accessing the URL described in the e-mail. The technique according to the present disclosure improves usability in the method of presenting the diagnosis result of the image processing apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2025-002820 filed January 8, 2025, and No. 2025-120535 filed July 17, 2025, which are hereby incorporated by reference herein in their entirety.

What is claimed is:

1. An image processing apparatus including a display unit displaying various information, comprising one or more processors and/or circuitry which function as:
an obtaining unit configured to obtain, based on a predetermined condition, an available method from among a plurality of different methods in which a diagnosis result of an error that has occurred during an operation of the image processing apparatus is confirmed in methods different from displaying the diagnosis result on the display unit; and
a display control unit configured to display a screen on the display unit, the screen displaying the available method obtained by the obtaining unit in a selectable mode,
wherein the display control unit displays, on the display unit, an unavailable method among the plurality of different methods in an unselectable mode in the screen.

2. The image processing apparatus according to claim 1, further comprising a providing unit configured to provide the diagnosis result of the error in a method selected by a user operation from among the available methods displayed on the display unit.

3. The image processing apparatus according to claim 1, wherein, in the unselectable mode, the unavailable method is grayed out on the screen or is not displayed on the screen.

4. The image processing apparatus according to claim 1, wherein the plurality of different methods are printing, e-mail transmission, confirmation on a mobile, and confirmation on a remote user interface (remote UI).

5. The image processing apparatus according to claim 4, wherein, in a case where the predetermined condition is that the diagnosis result of the error is printing impossible, the obtaining unit does not obtain the printing as the available method.

6. The image processing apparatus according to claim 4, wherein, in a case where the predetermined condition is that the diagnosis result of the error is e-mail transmission impossible, the obtaining unit does not obtain the e-mail transmission as the available method.

7. The image processing apparatus according to claim 4, wherein, in a case where the predetermined condition is that access to a remote UI by a log-in user is limited, the obtaining unit does not obtain the confirmation on the remote UI as the available method.

8. The image processing apparatus according to claim 1, further comprising a setting unit configured to set available or unavailable for each of the plurality of different methods,
wherein the obtaining unit does not obtain the method set to unavailable in the setting unit, as the available method.

9. The image processing apparatus according to claim 8, wherein the display control unit causes the method set to unavailable in the setting unit to be displayed on the display unit in the unselectable mode on the screen.

10. The image processing apparatus according to claim 9, wherein, in the unselectable mode, the unavailable method is grayed out on the screen or is not displayed on the screen.

11. The image processing apparatus according to claim 4, wherein the confirmation on the mobile is confirming the diagnosis result of the error by reading a two-dimensional code displayed on the screen or a printed two-dimensional code with a user terminal.

12. The image processing apparatus according to claim 1, wherein transition to the screen is performed from a diagnosis result screen displaying the diagnosis result of the occurred error.

13. The image processing apparatus according to claim 1, wherein transition to the screen is performed from a history screen that is displayed prior to transitioning to a diagnosis result screen displaying the diagnosis result of the occurred error and that displays a history of each type of the occurred error.

14. The image processing apparatus according to claim 13, further comprising a providing unit configured to provide the diagnosis result of the error in a method selected by a user operation from among the available methods displayed on the display unit.

15. The image processing apparatus according to claim 14, wherein, in a case where e-mail transmission is selected by the user operation from among the available methods, the providing unit provides the diagnosis result of the error by transmitting an e-mail to a designated destination, the e-mail including description of uniform resource locator (URL) for confirming the diagnosis result of the error on a remote UI.

16. The image processing apparatus according to claim 14, wherein, in a case where confirmation by a mobile is selected by the user operation from among the available methods, the providing unit provides the diagnosis result of the error by displaying, on the screen, a two-dimensional code for confirming the diagnosis result of the error on a user terminal.

17. A method of controlling an image processing apparatus including a display unit displaying various information, comprising:
obtaining, based on a predetermined condition, an available method from among a plurality of different methods in which a diagnosis result of an error that has occurred during an operation of the image processing apparatus is confirmed in methods different from displaying the diagnosis result on the display unit;
displaying a screen on the display unit, the screen displaying the available method obtained in the obtaining in a selectable mode; and
displaying, on the display unit, an unavailable method among the plurality of different methods in an unselectable mode in the screen.

18. A non-transitory computer readable storage medium storing a program which causes a computer to execute a method of controlling an image processing apparatus including a display unit displaying various information, the method comprising:
obtaining, based on a predetermined condition, an available method from among a plurality of different methods in which a diagnosis result of an error that has occurred during an operation of the image processing apparatus is confirmed in methods different from displaying the diagnosis result on the display unit;
displaying a screen on the display unit, the screen displaying the available method obtained in the obtaining in a selectable mode; and
displaying, on the display unit, an unavailable method among the plurality of different methods in an unselectable mode in the screen.
